(19) United States
(12) Patent Application Publication
(10) Pub. No.: US 2026/0121941 A1
(43) Pub. Date: Apr. 30, 2026

(54) REPRESENTING UNDERLYING LOGICAL CONSTRUCTS RELATED TO TEMPORAL SENSING AND MEASURING OF A RADIO ENVIRONMENT

(71) Applicant: Huawei Technologies Co., Ltd., Shenzhen (CN)

(72) Inventors: Yiqun Ge, Kanata (CA); Wuxian Shi, Kanata (CA); Wen Tong, Ottawa (CA)

(21) Appl. No.: 19/003,887

(22) Filed: Dec. 27, 2024

Related U.S. Application Data
(63) Continuation of application No. PCT/CN2022/102904, filed on Jun. 30, 2022.

(51) Int. Cl. H04L 41/16; G06N 3/08; H04W 24/02

(52) U.S. Cl. CPC H04L 41/16; G06N 3/08; H04W 24/02

(57) ABSTRACT

Some implementations of the present disclosure provide a method of discovering these logical constructs and representing the logical constructs in a concise manner so that the logical constructs may be efficiently shared and stored. More specifically, some implementations of the present disclosure relate to training a deep neural network autoencoder to obtain at least one sparse equation. An indication of an adjustment to a parameter in use in a wireless communication environment, may be transmitted, to a device in the wireless communication environment, where the adjustment to the parameter is determined using the sparse equation.

### CROSS-REFERENCE TO RELATED APPLICATIONS

This application is a continuation of International Application No. PCT/CN2022/102904, entitled “REPRESENTING UNDERLYING LOGICAL CONSTRUCTS RELATED TO TEMPORAL SENSING AND MEASURING OF A RADIO ENVIRONMENT” filed on Jun. 30, 2022, which is hereby incorporated by reference in its entirety.

### TECHNICAL FIELD

The present disclosure relates, generally, to temporal sensing and measuring of a radio environment and, in particular embodiments, to representing underlying logical constructs of such environments with sparse equations.

### BACKGROUND

Modern cellular systems are known to be considered to comply with a fifth generation (5G) of wireless communication standards. The term “new radio (NR)” is used to reference an air interface portion of the 5G standard. NR is designed to be the global standard for the air interface of 5G networks.

5G NR communication systems are allowing for connecting, to a network, increasing numbers of Internet-of-Things (IoT) devices and sensors. This case of increasing numbers may be considered especially true for vertical industries, such as manufacturing, farming and the like. In general, IoT devices or sensors are designed to continuously obtain measurement data and send the measurement data to a destination, thereby resulting into a collection of multiple-dimensional temporal measurement data at the destination.

There may be many ways to determine logical constructs underlying the collection of multiple-dimensional temporal measurement data. However, determining the logical constructs in a manner that allows the logical constructs to be generalized beyond the environment in which the measurement data was obtained may be difficult.

### SUMMARY

Some embodiments of the present disclosure provide a method of discovering logical constructs and representing the logical constructs in a concise manner so that the logical constructs may be efficiently shared and stored. The found and concise logical constructs can be used in a digital twin model that allows for recording and predicting changes in the real physical environment. But, the first step is to find out a model, e.g., a logical construct, from an amount of measurement data. More specifically, some embodiments of the present disclosure relate to training a deep neural network autoencoder to obtain at least one sparse equation. An indication of an adjustment to a parameter, in use in a wireless communication environment, may be transmitted to a device in the wireless communication environment, where the adjustment to the parameter is determined using the sparse equation.

When measurement data has high dimensionality, a linear fitting approach to determining logical constructs may fit the measurement data well. However, there may be an overfitting problem. That is, it may be difficult to generalize on the basis of the determined logical construct.

Through the training of a deep neural network autoencoder, determined logical constructs may have general application beyond the environment in which the measurements were obtained for the training.

According to an aspect of the present disclosure, there is provided a method for adjusting parameters used in a wireless communication environment. The method includes obtaining a library function based on a measurement vector, wherein measurement vector represents a plurality of measurements of the wireless communication environment and the measurement vector. The method further includes obtaining a trained sparse coefficient matrix by optimizing a training target by obtaining, using an input data vector and first phase training of a deep neural network autoencoder, an output data vector, wherein the first phase training includes learning an encoder gradient for an encoder part of the deep neural network autoencoder and learning a decoder gradient for a decoder part of the deep neural network autoencoder. The optimizing the training target includes minimizing a loss function. The method further includes obtaining, via second phase training of the deep neural network autoencoder, a primary predicted derivative of the input data vector, the second phase training using the encoder gradient, the decoder gradient and a derivative of the input data vector. The method further includes obtaining, via third phase training of the deep neural network autoencoder, a secondary predicted derivative of the input data vector, the third phase training using the library function, the sparse coefficient matrix and the decoder gradient. The method further includes obtaining, based on a combination of the sparse coefficient matrix and the library function, a sparse equation and transmitting, to a device in the wireless communication environment, an indication of an adjustment to a parameter in use in the wireless communication environment, the adjustment to the parameter determined using the sparse equation.

The sparse equation obtained using above method may be considered to be a logical construct that may have general application beyond the environment in which the measurements were obtained for the training. The sparse equation may be understood to represent logical constructs in a concise manner so that the logical constructs may be efficiently shared and stored.

According to an aspect of the present disclosure, there is provided an apparatus configured to adjust parameters used in a wireless communication environment. The apparatus includes memory storing instructions and a processor. The processor is caused, by executing the instructions, to obtain a library function based on a measurement vector, wherein measurement vector represents a plurality of measurements of the wireless communication environment and the library function represents a set of candidate non-linear functions of columns of the measurement vector. The processor is further caused, by executing the instructions, to obtain a trained sparse coefficient matrix by optimizing a training target by obtaining, using an input data vector and first phase training of a deep neural network autoencoder, an output data vector, wherein the first phase training includes learning an encoder gradient for an encoder part of the deep neural network autoencoder and learning a decoder gradient for a decoder part of the deep neural network autoencoder and wherein, the optimizing the training target includes minimizing a loss function. The processor is further caused, by executing the instructions, to obtain, via second phase training of the deep neural network autoencoder, a primary predicted derivative of the input data vector, the second phase training using the encoder gradient, the decoder gradient and a derivative of the input data vector. The processor is further caused, by executing the instructions, to obtain, via third phase training of the deep neural network autoencoder, a secondary predicted derivative of the input data vector, the third phase training using the library function, the sparse coefficient matrix and the decoder gradient. The processor is further caused, by executing the instructions, to obtain, based on a combination of the sparse coefficient matrix and the library function, a sparse equation and transmit, to a device in the wireless communication environment, an indication of an adjustment to a parameter in use in the wireless communication environment, the adjustment to the parameter determined using the sparse equation.

According to an aspect of the present disclosure, there is provided a non-statuary computer readable medium storing instructions thereon, where when the instructions are executed by a processor, the method described in above aspect is implemented.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point (TRP) and an example non-terrestrial TRP, in accordance with aspects of the present application;

FIG. 5 illustrates, as a block diagram, a sensing management function, in accordance with aspects of the present application;

FIG. 6 illustrates a context for obtaining measurements of a moving user equipment (UE), in accordance with aspects of the present application;

FIG. 7 illustrates an example trajectory of a UE relative to a TRP;

FIG. 8 illustrates results produced by determining, for the trajectory of FIG. 7, a predicted Doppler shift relative to an original Doppler shift using a model in accordance with aspects of the present application;

FIG. 9 illustrates a sparse coefficient matrix determined in accordance with aspects of the present application;

FIG. 10 illustrates results produced by determining, for trajectories distinct from the trajectory of FIG. 7, a predicted Doppler shift relative to an original Doppler shift using a model in accordance with aspects of the present application;

FIG. 11 illustrates results produced by determining, for trajectories distinct from the trajectory of FIG. 7, a predicted Doppler shift relative to an original Doppler shift using a model in accordance with aspects of the present application;

FIG. 12 illustrates results produced by determining, for two distinct trajectories, a predicted Doppler shift relative to an original Doppler shift using a model in accordance with aspects of the present application;

FIG. 13 illustrates a sparse coefficient matrix trained in accordance with aspects of the present application;

FIG. 14 illustrates results for a first UE produced by determining, for trajectories distinct from the trajectories used to obtain the results of FIG. 12, a predicted Doppler shift relative to an original Doppler shift using a model in accordance with aspects of the present application;

FIG. 15 illustrates results for a second UE produced by determining, for trajectories distinct from the trajectories used to obtain the results of FIG. 12, a predicted Doppler shift relative to an original Doppler shift using a model in accordance with aspects of the present application;

FIG. 16 illustrates a scenario wherein a UE is moving along a trajectory while sending information to, or receiving information from, three nearby TRPs;

FIG. 17 illustrates an example trajectory of a UE relative to three TRPs;

FIG. 18 illustrates results for a preferred model for a first TRP in FIG. 17 in accordance with aspects of the present application;

FIG. 19 illustrates results for a preferred model for a second TRP in FIG. 17 in accordance with aspects of the present application;

FIG. 20 illustrates results for a preferred model for a third TRP in FIG. 17 in accordance with aspects of the present application;

FIG. 21 illustrates unknown trajectory results for the preferred model for the first TRP in FIG. 17 in accordance with aspects of the present application;

FIG. 22 illustrates unknown trajectory results for the preferred model for the second TRP in FIG. 17 in accordance with aspects of the present application;

FIG. 23 illustrates unknown trajectory results for the preferred model for the third TRP in FIG. 17 in accordance with aspects of the present application;

FIG. 24 illustrates new locations results for the preferred model for the first TRP in FIG. 17 in accordance with aspects of the present application;

FIG. 25 illustrates new locations results for the preferred model for the second TRP in FIG. 17 in accordance with aspects of the present application;

FIG. 26 illustrates new locations results for the preferred model for the third TRP in FIG. 17 in accordance with aspects of the present application;

FIG. 27 illustrates an example trajectory of a UE relative to three TRPs, with some propagation obstructed by a building;

FIG. 28 illustrates shadowed results for the preferred model for the first TRP in FIG. 27 in accordance with aspects of the present application;

FIG. 29 illustrates shadowed results for the preferred model for the second TRP in FIG. 27 in accordance with aspects of the present application;

FIG. 30 illustrates shadowed results for the preferred model for the third TRP in FIG. 27 in accordance with aspects of the present application;

FIG. 31 illustrates an example three-dimensional scenario;

FIG. 32 illustrates respective trajectories for a UE in motion and a non-terrestrial (NT) TRP in motion;

FIG. 33 illustrates results for a preferred model for the NT-TRP in FIG. 32 in accordance with aspects of the present application;

FIG. 34 illustrates respective trajectories for a UE in motion and a NT-TRP in motion;

FIG. 35 illustrates results for a preferred model for the NT-TRP in FIG. 34 in accordance with aspects of the present application;

FIG. 36 illustrates respective trajectories for a UE in motion and a NT-TRP in motion; and

FIG. 37 illustrates results for a preferred model for the NT-TRP in FIG. 36 in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (e.g., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

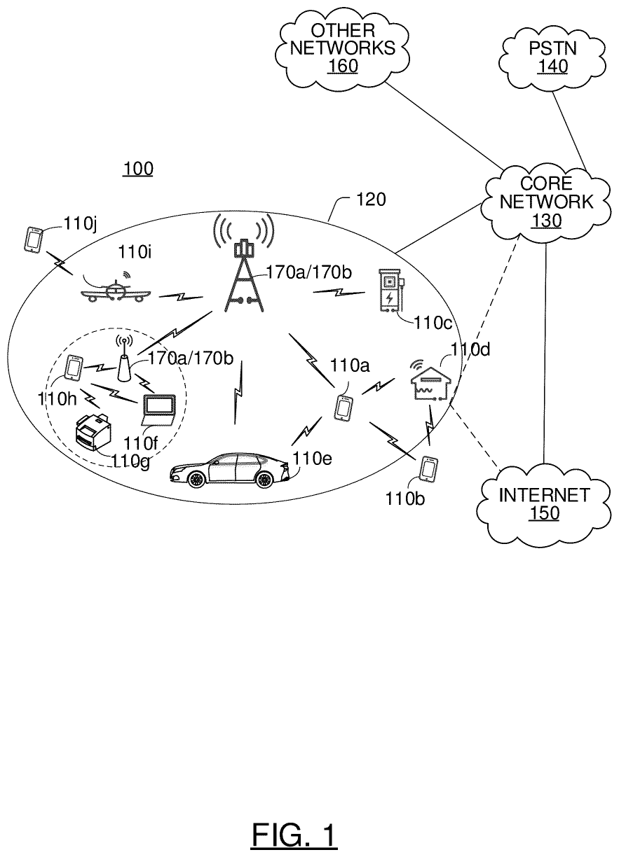

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

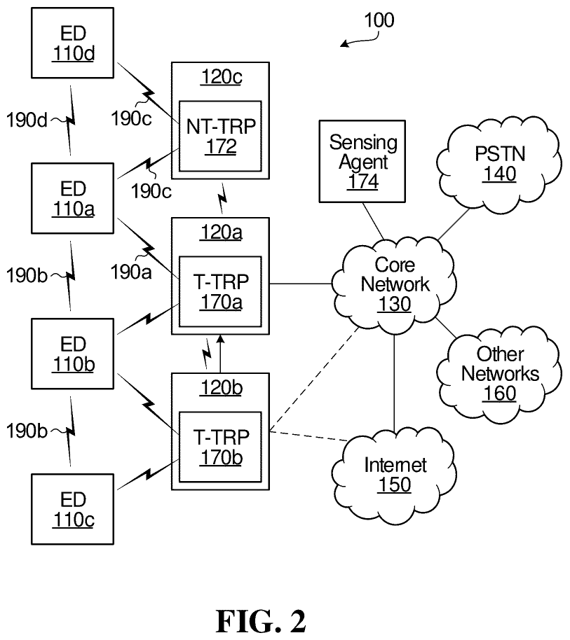

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

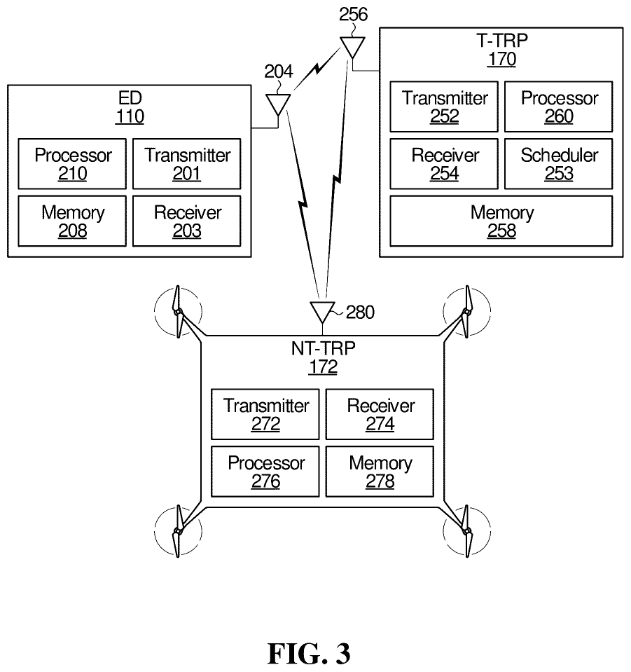

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (e.g., established, activated or enabled), turned-off (e.g., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

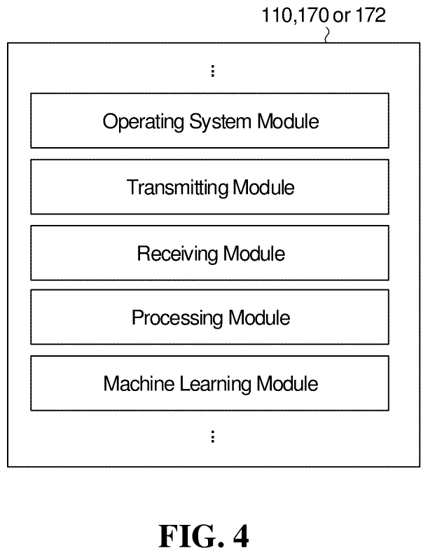

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, e.g., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler shift); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (e.g., duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the downlink control information (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

User Equipment (UE) position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

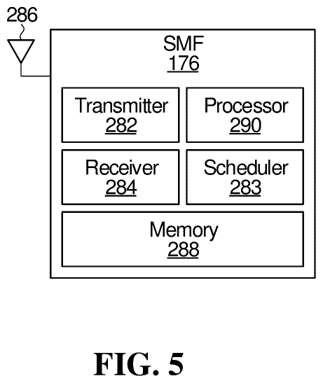

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (e.g., format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t-t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

5G NR communication systems may be shown to enable large scale deployment of a “digital twin” concept. A digital-twin concept is expected to be introduced into future wireless systems, especially for sensing and communication. Instead of maintaining a record of different types of real-time measurement data, it may be considered to be more efficient and generalized for the network to determine underlying logical constructs behind a great amount different-modal data measurements. The digital twin concept may be shown to involve three distinct parts: a physical entity; a digital/virtual entity; and connections between the two entities. The connections between the physical entity and the digital/virtual entity may be represented as the state flows of the physical entity mapped onto the digital/virtual entity and inference information that is available from the digital/virtual entity mapped onto the physical environment. The physical entity and the digital/virtual entity may be collectively referenced as “the digital twins.”

According to aspects of the present application, measurement data obtained from widely distributed and densely connected IoT devices and sensors may be aggregated. The aggregation of the measurement data may allow for interrogation of various physical entities. The aggregation of the measurement data may also allow for prognostics, learning, prediction and inference.

The digital twins may be said to contain information. It is generally considered that a given system employs the digital twin concept to obtain specific information. The specific information that the given system seeks to obtain from the digital twins may be understood to vary according to the use case. It should be clear that “obtaining” such information may involve interpolation, inference or prediction. The given system may be arranged to obtain specific information from digital twins and, on the basis of the specific information, the given system make take some action.

A logical construct may be defined as a concise description of the specific information. Instead of storing a large amount of raw measurement data, it is proposed herein that some logical constructs may be hidden below the raw measurement data. Aspects of the present application relate to discovering these logical constructs and representing the logical constructs in a concise manner so that the logical constructs may be efficiently shared and stored.

Accordingly, the given system may be arranged to obtain specific information from digital twins. On the basis of the specific information, the given system may be arranged to discover a logical construct underlying or governing the specific information. On the basis of the logical construct, the given system may take some action.

Wireless communication systems may be considered to be among a set of systems for which benefit may be realized through the obtaining of specific information from digital twins, the making of use of that specific information for discovering underlying logical constructs and making use of the logical constructs to predict, infer and take some action. That is, wireless communication may qualify as a suitable use case for this approach.

It may be shown that this approach may allow for provision of reliable and efficient transmission in a radio area in which radio channels are affected by many factors. Such factors may include position of a UE, mobility of a UE, building density and so on.

Aspects of the present application relate to making use of logical constructs to predict, interpolate, infer and take some action. A “prediction/inference” in the context of wireless communication may relate to predicting, based on the current observation of the current wireless channel-related measurements, possible states in the following time intervals. An “interpolation” in the context of wireless communication may relate to determining, based on the observation of some wireless channel-related measurements, missing or noised measurements. An “action” in the context of wireless communication may relate to: scheduling transmission to/from multiple users; compressing channel measurement; a speed at which channels are measured; and allocating, to users, radio resources (coding rate, bandwidth, bands, etc.).

Before an action is implemented physically, strategic algorithms that are related to the carrying out of the action may be subject to verification, through emulation in a virtual environment. Such verification may be seen to maximize an expectation of a system gain that may be realizable though the physical implementation of the action. Establishing an appropriate virtual environment may involve obtaining and using specific information about the radio environment experienced by radio access nodes (e.g., eNodeB, gNodeB) within the radio environment. Establishing the virtual environment may involve establishing a digital twin of the radio environment. Once the virtual environment has been established, actions may be emulated in the virtual environment in a manner that allows for a determination of an optimal action.

It is believed that a logical construct may be built upon a logical relationship among multiple temporal measurements. For example, consider that a given temporal measurement, A(t), is a function of a first temporal measurements, B(t), and a second temporal measurement, C(t). Further consider that it is much more expensive to obtain the given temporal measurement, A(t), than it is to obtain the first temporal measurement, B(t), and the second temporal measurement, C(t). It may be considered reasonable to only obtain the first measurement, B(t), and the second measurement, C(t), rather than obtaining the given temporal measurement, A(t). In other words, the task of obtaining the given temporal measurement, A(t), may not be carried out, thereby leading to increased sparsity.

Notably, if A(t) is missed or heavily noised, by the first measurement, B(t), and the second measurement, C(t), the A(t) can be estimated.

Furthermore, if logical relationships among given temporal measurement, A(t), the first measurement, B(t), and the second measurement, C(t), are known and the logical relationships remain, then the virtual entity can infer or predict A(t+Δt), the first measurement, B(t+Δt), and the second measurement, C(t+Δt) at the next few time (t+Δt).

Moreover, a number of logical constructs may be considered initial conditions for building a digital twin system. The logical constructs represent the hidden, but governing, relationship(s) among various temporal measurements, which may be considered to be a multiple-modal dynamic representation of the physical entity. This multiple-modal dynamic representation is an important and fundamental part of a digital twin system.

The sparsity matches a belief that our physical environment, though exhibiting randomness, noise, missing and diversity, is dominated by only a few physical laws. It means that the logical constructs could be much more concise than raw measurement data. Notably, a logical construct may be closer to the essential physical laws that yield the raw data.

For example, classic mechanics has, for decades, allowed for the building of digital twin systems in modern engineering domains. Example digital twin systems are implemented in computer-aided design (CAD), computer-aided engineering (CAE) and computer-aided automation (CAA).

In the wireless communication use case, it may be illustrated that prior knowledge of a radio environment may be employed to: optimize a deployment of IoT sensors; optimize the performance, by the IoT sensors, of certain measurements; and optimize the provision, by the IoT sensors, of feedback. Notably, the feedback may include indications of the measurements.

It may be shown that 5G technologies are being used to connect a large quantity of IoT devices and IoT sensors. In some implementations, the IoT devices and IoT sensors may be of a wide variety of types and the IoT devices and IoT sensors may be deployed over a wide area.

Aspects of the present application relate to determining whether the unprecedented quantity of measurement information contains some heretofore unknown logical constructs that may be exploited. A system that exploits logical constructs underlying measurement information may be considered to be a “next-level” digital twin system that provides an extension to the knowledge that may be gleaned from the measurement information. Ideally, an entity implementing such a system may profit from the extension.

One possible way of determining whether measurement information contains underlying logical constructs involves use of machine learning (ML) technology. Indeed, ML may be employed to learn of inter-relationships among spatial-temporal measurements. In one instance, the inter-relationships may be found to occur among spatial-temporal measurements of the same type. In another instance, the inter-relationships may be found to occur among spatial-temporal measurements of different type. However, a statistical correlation may only be superficially learned. Furthermore, the statistical correlation may be too environment-dependent to be widely generalized.

In contrast, classic physical laws, such as the known physical laws related to mechanics and the known physical laws related to electromagnetism, may be considered to be too generalized to be applied to the wireless communication use case.

ML may be shown to have major challenges, especially when deep neural network (DNN) are employed to carry out the ML, when it comes to determining logical constructs that underly measurement information. One challenge relates to distinguishing between key factors and weak factors.

Another challenge that is related to the determination of an underlying logical construct on the basis of a large quantity of IoT measurements is that a true, physical world may involve non-linear dynamics. For example, classic mechanics and electromagnetism are known to be non-linear and dynamic. It is possible that a task, in a particular case, may involve attempting to determine a digital twin system for an unknown, non-linear, dynamic system. Notably, the term dynamic system is used herein to denote a system that changes with time.

A further challenge relates to randomness. Measurements and transmissions are known to be unreliable in that offsets and noises are everywhere. A practical world does not necessarily behave in a manner that a virtual world behaves in a laboratory. Some measurements may simply be representative of disturbances. Identification and removal of such disturbances may be tasks given to a digital twin system. The benefit of identification and removal of disturbances may be understood to be straightforward: a large reduction of measurement events and transmission events.

Aspects of the present application relate to the implementation of a digital twin system in the context of a wireless communication system. For example, some part of a radio channel for a UE may be effected by factors that go beyond the environment or the surroundings of the UE. Such factors may include positioning of the UE and a velocity of the UE. Some logical constructs may be evident; some logical constructs may not be evident; some logical constructs may even be hidden and combinatory. Because it is expensive to consume radio resource to measure a time-varying radio channel, the finding of an underlying logical construct using a digital twin, may allow a system to benefit from use of some cheaper environmental sensors.

In overview, aspects of the present application relate to discovering a logical construct underlying a number of multiple-modal (different type) spatial-temporal measurements. The underlying logical construct may reveal some causations and allow for removal of some irrelevant causations. The discovered logical construct may be generalized and persistent (e.g., remaining unchanged over long time) enough to be applied to sites that are distinct from the site at which the measurements were obtained.

Given a number of IoT devices or IoT sensors, either same type or different types, that obtain temporal measurements of multiple types, aspects of the present application relate to automating the discovery of underlying logical constructs hidden in multiple types (modalities) of temporal measurements.

However, it may be shown to be difficult to automatically discover some hidden logical constructs in multiple types of temporal measurements.

A logical construct reflects a causation rather than a superficial correlation in statistical term. For example, in the case of two temporal measurements, A(t) and B(t), it is preferred to have a logical construct that the change of A(t) is in a function of B(t) rather than A(t) and B(t) are somehow correlated. That is, expressed mathematically,

$$\frac{Δ A ( t )}{Δ t} = f ( B ( t ) ; θ )$$

is preferred over <A(t), B(t)>>σ.

A given logical construct may be considered to be general enough that the given logical construct may be applied to other, similar environments. The given logical construct may be considered to reflect commonality more than the given logical construct reflects particularity. Some factors specific to measuring an environmental particularity may be removed. For example, among three temporal measurements, A(t), B(t) and C(t), obtained in a particular measuring environment, it may be that C(t) depends on only the particular measuring environment. Accordingly, it is preferred that a discovered logical construct is a logical construct that eliminates C(t), thereby allowing for more generalization.

A logical construct may be represented in a sparse way. In consideration of a number of temporal measurements in a multi-dimensional temporal data space in which a logical construct is searched and established, the complexity of this discovered logical construct matters for sharing knowledge and other implications. For example, among four temporal measurements, A(t), B(t), C(t), and D(t), when a first causal logical construct between A(t) and B(t) dominates and persists much more than a second causal logical construct between C(t) and D(t), it is preferred to keep the first causal logical construct between A(t) and B(t) and eliminate the second causal logical construct.

The measurements may be understood to be time-varying, instead of being merely statistical snapshots. As a class, it may be considered that physical laws generally relate to time-varying systems. Similarly, the logical constructs discovered according to aspects of the present application are expected to be representative of a dynamic system. That is, rather than simply being a linear fitting, the logical constructs discovered according to aspects of the present application are expected to have high dimensionality.

It is known to automatically discover underlying logical constructs given a collection of measurement data. However, the known approaches may be seen to be flawed.

In a first approach, an underlying logical construct is represented by linear fitting functions. Although physical phenomena are typically non-linear and time-varying, some physical phenomena can, in theory, be represented by high dimensional (polynomial) functions. With such high dimensionality, the determined logical construct may fit the measurement data well. However, there may be an overfitting problem. That is, is may be difficult to generalize on the basis of the determined logical construct.

In a second approach, an underlying logical construct is represented by a deep neural network. Since deep neural networks are known to be non-linear, the underlying logic construct is somehow “absorbed” or “hidden” or learnt into the coefficients of the neurons. However, due to poor interpretability, a DNN can neither reveal causation among the measurements nor remove any irrelevant or trivial measurements. When a large number of neurons (coefficients) are used, the second approach may be shown to suffer from the same overfitting issue that may be seen in the first approach. Moreover, to share a logical construct learnt according to the second approach may be shown to involve a transmission of all the neurons of a DNN. Under some circumstances, such a transmission would involve transmission of billions of floating-point values.

Aspects of the present application relate to a method to learn sparse equations from collected measurements. The sparse equations may be represented by a combination of a library function and a sparse coefficient matrix.

As is known in the context of most physical laws, an equation may be used as a general form to describe a logical construct and causation. Such an equation may be considered to clearly provide an indication of causation among the variables and to provide weights representative of a contribution associated with each variable. An equation may be said to have “sparsity” when the equation removes most irrelevant measurements. Irrelevant measurements are mostly understood to environment-specific. When a sparse equation is used to describe a logical construct, the generalization available from the logical construct may be shown to be a significant improvement over logical constructs determined using the known approaches. Furthermore, when a sparse equation is used to describe a logical construct, the description has a conciseness advantage logical constructs determined using the known approaches. The conciseness advantage shows value, in particular, when the logical construct is to be shared and/or transferred between entities.

According to aspects of the present application, a deep neural network may be used to obtain sparse equations on the basis of a plurality of measurements. Notably, the manner in which the DNN is trained in aspects of the present application is distinct from the manner in which the DNN is trained in the second approach referenced hereinbefore. In aspects of the present application, gradients that are determined during a backward propagation stage of the training process for the DNN are of primary interest. This interest is due to the gradient being reflective of the change of the measurements over the time. This, of course, supposes that the measurements are given in a natural timing order. Aspects of the present application relate to obtaining, using the gradients determined in the backward propagation stage, sparse equations. At the end of the training process, the resultant sparse equations may be shared as logical constructs. Conveniently, the resultant sparse equations may be used to generalize such that a collection of measurements in a distinct environment may be processed to obtain predictions.

The sparse equations may be expressed as sparse, non-zero coefficients over a predefined operator matrix, which matrix is high dimensional. “L1 Norm” is one training regulation among many training regulations that may be used to force a sparsity of the operator matrix. In Linear Algebra, a Norm refers to the total length of all the vectors in a space. The so-called “L1 Norm” is the sum of the magnitudes of the vectors in a space.

In general, those physical laws that have been discovered justify an assertion that the physical world is “sparse.” Indeed, physical discoveries are often derived as transformations of natural measurements obtained in a physical domain to representations in sparser domains. The transformed measurements may be addressed in the sparser domains so that underlying logical constructs may be determined.

A natural phenomenon is often multiple-dimensional, irregular, non-linear, and temporally dynamic. It may be shown to be difficult to analyze and process the natural phenomenon directly. Scientists have to regularize and transform the measurements of a natural phenomenon into a low-dimensional, regular and quasi-stationary domain that is sparse, e.g., a domain in which only a few entries (dimensions) are non-zero. Radio signal propagation is a natural phenomenon. In many conventional systems, samples representative of radio signal propagation have been transformed into some sparse representations.

Among alternative sparse representations for a series of physical measurements (samples), sparse equations are of interest because sparse equations may indicate and reveal some dependency, causation and relativity among multiple spatial-temporal physical dimensions (or variables) in a more generalized way. When a physical spatial-temporal phenomenon has a few relevant terms to define inherent dynamics, a corresponding sparse equation representation may be a concise multiple-dimensional non-linear function space. For example, Newton discovered dynamics between momentum and energy that describes elliptic orbits. Conveniently, Newton's equations may be shown to predict behavior in regimes where no data has been collected.

Equations in the field of physics correspond to Kolmogorov complexity in the field of algorithmic information theory. Kolmogorov complexity designates the amount of the information of a stochastic sequence to be the length of the shortest or sparsest program to yield that sequence as an output. That is to say, the act of finding equations that yield a sequence is equivalent to the act of finding equations that represent that sequence.

However, it is not necessarily easy to find an underlying equation from a plurality of measurement data (say, a number of sequences of samples). An alternative provided by classic information theory is to find a typical set in a Bayesian view. The amount of information is measured as a function of a probability uncertainty on the set of possible sequences, independent of the meaning, structure, semantic or content of individual messages. Shannon's view allows for the identification of a most typical set to represent the data and measurements by hiding the underlying causations, semantics and topologies.

Another alternative involves finding a most dominant (also known as “essential”) modes in classic model theory. For example, the known Principal Component Analysis (PCA) approach uses two orthogonal and linear transformations to convert a set of correlated variables (or dimensions) into a set of uncorrelated (or independent) components. The most important components may represent the multiple-dimensional data or represent a signal. However, the known PCA approach inherits assumptions and limitations; the PCA approach is based on an assumption of a correlation among variables (or some inherent commonality among the dimensions) statistically. Since the PCA approach is a linear decomposition (note that the way to decompose it is non-linear singular value decomposition), the PCA approach involves requesting more linear dimensions to describe a simple non-linear natural phenomenon. In theory, a non-linearity can be represented by an infinitive number of dimensions. The known PCA approach remains a powerful technique for dimensionality reduction, information compression, data de-noising and so on. In practice, principal components are sufficient to approximate an original dataset without the need for additional features. It follows that the PCA approach, and its variation versions, has been a main dimension-reduction weapon in image compression and MIMO rank detection. Last but not least, the eigen-vectors and eigen-functions (U and V) are interpretable to some degree as each successive principal components explains the variance or commonality that is left after its preceding components. However, if a phenomena is triggered non-linearly temporally by a set of physical laws, with most of the physical laws being described by a differential equation that forms a dynamic system with time, the principle components found by the PCA approach may still be considered to be a superficial and statistic approximation rather than a fundamental understanding. For example, a PCA-approach-based MIMO rank detection solution may be shown to involve an assumption of a static channel condition. Once the channel condition varies, with time, away from the assumed static channel condition, the PCA-approach-based MIMO rank detection solution may be recalled to detect a new rank.

To conclude, sparsity is has been sought when describing complex systems. From a Kolmogorov complexity point of view, a measure of sparsity may be seen to represent the complexity of a program. From a Shannon Information Theory point of view, sparsity may be represented by a typical set. From a modal theory point of view, sparsity may be represented by principal components or persistent modes. In aspects of the present application, sparsity may be represented by equations in a high-dimensional temporal signal space with sparse coefficients.

In consideration of data sparsity, it is notable that deep neural network (DNN) technology may be considered to be a powerful learning tool for complex tasks, such as speech recognition and image processing. Learning by DNN may be considered to be representative of finding the most representative elements in a set of data. That is, learning by DNN may be said to implement data sparsity. Only the most representative elements have the most generalization. This compression has been well addressed and analyzed by so-called Information Bottleneck Theory and is often implemented in the architecture of an autoencoder. It may be considered that information on latent layers are the most essential and sparse information with regard to a training target.

A DNN usually includes a plurality of layers that act to progressively extract features from input. An input layer receives the input. An output layer provides output. Between the input layer and the output layer are one or more hidden layers. Each layer may have hundreds, or even thousands, of neurons. If data that reaches a particular hidden layer is not representative and sparse, it may be said that the DNN is naïvely trained. One common issue that arises with naïvely trained DNNs is overfitting. Naïvely trained DNNs are prone to overfitting because added layers of abstraction, which are features of naïvely trained DNNs, may cause a model that defines the DNN to have more parameters than can be estimated from a set of provided training data. It is known that there exist regularization methods that may be used, during training, to combat overfitting. Example regularization methods include sparsity (11 regularization) and weight decay (12 regularization). There also exist alternative (non-regularization) methods for preventing fitting. Example alternative methods are known as “dropout” and “augmenting data.” One consequence of overfitting is poor ability to generalize. The ability to extrapolate is especially relevant for forecasting in dynamical systems. One weakness of DNN models may be found in a failure of a given DNN models to predict a future events that was not represented in the training data that was used to train the DNN. The parameterizations for a DNN may be considered to be exceedingly large, which is the antithesis of sparse representation. During training, a DNN model is typically tuned by making adjustments to a large amount of neurons to fit data. This approach is clearly distinct from efforts to find an underlying mathematical relationship between variables. It follows that a typically trained DNN is not able to produce accurate prediction output for regimes for which the typically trained DNN has not been trained.

An autoencoder is a type of artificial neural network. A DNN may be said to force input to fit an output. In contrast, an autoencoder may be said to learn to copy its input to its output through compression and reconstruction. A typical autoencoder has an internal layer that describes a code used to represent the input and that separates the autoencoder into two parts: an encoder part that maps the input to the code; and a decoder part that maps the code to a reconstruction of the input. Similar to DNNs, autoencoders are known to have poor interpretability and generalizability. Even though an autoencoder is generally useful in dimensional reduction and data reconstruction, an autoencoder is still unable to express a dynamic between variables over time. As a result, if the properties of the input change, a trained an autoencoder model may become outdated. This may be seen as an explanation regarding why most autoencoder-based applications are for images or natural languages, which are not as dynamic as radio channels.

Another limitation of DNNs is lack of interpretability of the resulting models. While attempts have been made to interpret the parameters, such as weights, network architectures are typically complicated with a large number of parameters. The lack of interpretability also makes it difficult to generalize a given DNN model to a new regime. However, it may be shown that a DNN model has the potential to learn general dynamic equations, if the DNN model is properly constrained. Thus, aspects of the present application relate to finding a model that can incorporate the DNN-based methods and sparse regression methods to discover models with interpretability and generalization.

An initial step, toward finding a desired model, involves settling upon an appropriate coordinate system to demonstrate data sparsity. This step is known from classic workflow. In model theory, it is what the PCA approach does. The Eigen-vectors (U) or Eigen-functions (V) of the PCA approach use a particular coordinate system that helps to illustrate data sparsity on a linear domain, Σ (eigen values or singular values). In deep learning, the encoding part and the decoding part of an autoencoder use a particular coordinate system that helps to illustrate data sparsity on a non-linear latent layer. Besides, the famous Fourier transformation is widely applied to non-sparse signals in the time domain to illustrate the sparsity of these signals in the frequency domain. Derivatives of the Fourier transformation, such as Discrete Fourier Transform (DFT), Fast Fourier Transform (FFT), Discrete Cosine Transform (DCT), Wavelet, Short-Time-Fourier-Transformation (STFT), may be shown to make solid foundations for many modern engineering and scientific achievements. In sum, one important objective of a transformation (either linear or non-linear) is to demonstrate some sparsity in a multiple-dimensional signal space. Once an appropriate coordinate system has been settled upon, a set of input data may be transformed to the settled upon coordinate system so that the input data becomes sparse data.

A subsequent step, toward finding a desired model, involves finding a function (say, a polynomial), or an equation, to fit the sparse data. It can be shown that many transformers (linear or non-linear) include an assumption that a sparsity remains during a coherent window. That is, these transformers may be shown to ignore the observation that a multiple-dimensional signal can make up a dynamic system with time. It may further be shown that many conventional transformers sometimes act to simplify a multiple-dimensional dynamic into a time-varying linear combination. For example, a conventional transformer may simplify a radio channel into a tapped delay line (TDL) model. As a result, a linear-combination model that represents a dynamic system tends to, through transformation, adopt many more dimensions than were found in the original dynamic system. As another result, the widely used fitting algorithm on a linear model is linear regression to optimize an l₂ regularization norm. If a linear model tries to fit sparse data that includes many outliers, the linear model may fit the sparse data too well to provide accurate test data prediction. Fitting a linear model to the sparse data may involve adding more coefficients (dimensions) than necessary. This addition of coefficients may be regarded as a major reason for the overfitting and poor generalization associated with this approach.

Clearly, it may be considered challenging to find sparse equations for a dynamic system in a multiple-dimensional signal space. Aspects of the present application relate to carrying out the two steps, transformation and fitting, together. Aspects of the present application relate to exploiting machine learning strategies to simultaneously find an appropriate transformation and fit data into sparse equations.

Even though sparse equations are powerful for generalization, such sparse equations are either unknown or only partially known in many modern systems. Thanks to emerging (environmental) sensor and measurement technologies, many of these modern systems have rich time-series data (temporal measurements), which may be shown to enable the possibility of data-driven model discovery. For now on, consider that phenomena are observed and measured from different perspectives over a time period that includes discrete time moments, [t₁, t₂, t₃, . . . tv]. Additionally, consider that a large amount of samples, [z₁, z₂, z₃, . . . z_{K}], are obtained at the discrete time moments, where each sample (variable), zᵢ, is represented by a multiple-dimensional vector. Note that each sample, zᵢ, may be obtained with regard to an index that is distinct from a timing index. Accordingly, each sample, zᵢ, instead of being time-dynamic, may be space-dynamic, code-dynamic, etc. Each individual variable (sample), zᵢ, can be considered to be an entry in a thin (tall) measurement matrix (or vector), Z(t), representative of a sampling period (Z(t)=[z₁(t), z₂(t), z₃(t), . . . z_{K}(t)]), where the dimension, K, of the measurement vector, Z(t), is much greater than the dimension (|z₁|) of each individual entry, zᵢ. A sparse equation may be shown to describe a logical construct between the variables [z₁, z₂, z₃, . . . z_{K}] with regard to the sampling time, including: causation among different dimensions of zᵢ; irrelevance among the different dimensions of zᵢ; and non-linearity with time (dynamics) from z_{N} to z_{N+1}.

It is unknown whether the logical construct can be either linear or non-linear, either regression or non-regression. Although it may be considered to be easy to obtain a linear equation, a linear equation may be considered inadequate to capture most non-linear systems. For example, a non-linear pendulum system may be said to be governed by the second-order differential equation \ddot{z}=−sin z. It may be shown that the non-linear pendulum system cannot be described by simple linear terms of z. However, it may be shown that the non-linear pendulum system can be considered as a linear system about the non-linear term sin z. Given time-series measurements of Z(t)=[z₁(t), z₂(t), z₃(t), . . . z_{K}(t)], it may be shown to be easy to determine

$${{z}_{i} ( t )}^{2} , \frac{d {z}_{i} ( t )}{d t}$$

or even

$${\frac{{d}^{2} {z}_{i} ( t )}{d {t}^{2}}}^{}$$

from the measurements directly.

There exists a model for dynamic systems. The model may be expressed in a general-solution form. The general-solution form has been confirmed with many famous and widely accepted physical laws. The general-solution form is

$$\dot{Z} ( t ) = \frac{d}{d t} Z ( t ) = f ( Z ( t ) ) ,$$

where the vector, Z(t)∈Rⁿ, denotes the state of a dynamic system at a time, t, and the function, ƒ(Z(t)), represents the logical constructs for that dynamic system. The dynamic system can be generalized to include more terms such as time dependence, space dependence, code dependence, and the like. The function, ƒ, of interest may be shown to only include a few terms, making the function sparse in all the possible function spaces. Because of the sparse nature of the function, the problem may be reformulated as a sparse regression problem with the form:

$$\dot{Z} ( t ) = Θ ( Z ( t ) ) \cdot Ξ$$

where a library function, Θ(t), represents a set of candidate non-linear functions of columns of the measurement vector, Z(t). For example, the library function, Θ(t), may include constants, polynomials and trigonometric terms. Also, a sparse coefficient matrix, Ξ=[ξ₁ ξ₂ . . . ξₙ], is used here to represent a set of coefficients that may be used to determine active terms from the library function, Θ(t), in the dynamics of the function, ƒ. The choice of a basis function in the library function, Θ(t), which may also be called an operator matrix, usually reflects some background knowledge about the dynamic system of interest. A common choice of basis function in the library function, Θ(t), is a set of polynomials for curve-fitting. From an artificial intelligence perspective, the definition of the library function, Θ(t), may be considered as a “prior” given by human. It may be shown that the bigger the library function, Θ(t), is, the more the output of the function, ƒ, approaches the output of the true system.

Given the derivative, Ż(t), of the measurement vector, Z(t), and the library function, Θ(t), a least absolute shrinkage and selection operator (LASSO) algorithm (l₁ norm) may be used to obtain a sparse fitting of the data, e.g., the LASSO algorithm may be used to obtain the sparse coefficient matrix, Ξ. However, the LASSO algorithm may be computationally forbidden to large datasets and for high dimensional measurement vector, Z(t). Moreover, the derivative, Ż(t), of the measurement vector, Z(t), may not have been well transformed, that is, transformed in a manner that exhibits data sparsity.

In practice, the appropriate coordinate system and the corresponding transformation are unknowns. Additionally, an appropriate sparsity of the coordinates is also unknown. Accordingly, aspects of the present application relate to a method that simultaneously discovers an appropriate coordinate system and a sparse dynamic model.

In the general-solution equation, it may be shown that it is not easy to find the derivative, Ż(t)=Θ(Z(t))·Ξ. Aspects of the present application relate to a method of finding the derivative, Ż(t), that involves time derivatives. Suppose that the measurement vector, Z(t), is representative of the latent layer of a deep neural network, especially an autoencoder that may be described as: X(t) [symbol] Z′(t) [symbol] \hat{X}(t). The autoencoder has an encoding part represented by an encoding transforming function, φ. The autoencoder has a decoding part represented by a decoding transforming function, ψ. In short, the autoencoder may be represented by the transforming functions, [symbol] φ, ψ [symbol] .

The derivative, Ż(t), of the measurement vector, Z(t), may be represented using an expression, Ż(t)=∇_{X}φ(X(t))\dot{X}(t). This expression may be shown to be a by-product of the backward propagation operation that is used to train the autoencoder, [symbol] φ, ψ [symbol] . Notably, the symbol, ∇_{X}, is representative of the gradient used in the backward propagation stage of the training of the autoencoder, [symbol] φ, ψ [symbol] . Given different autoencoders, [symbol] φ, ψ [symbol] , there are different versions of the derivative, Ż(t), of the measurement vector, Z(t). The different versions reflect the impact of the transforming functions, φ and ψ, on the derivative, Z(t), of the measurement vector, Z(t).

Consider a goal of obtaining a high-dimensional input vector, X(t). It is known that the measurement vector, Z(t), is a K-dimensional vector for a time, t. Furthermore, it may be considered that the input vector, X(t), is a higher-dimensional (that is, L-dimensional) manifold linear span extension from the relatively lower-dimensional (K-dimensional) manifold, Z(t), e.g.,

$${x}_{i} ( t ) = {\sum }_{k = 1}^{K} {u}_{i , k} \cdot {z}_{k} ( t ) , i = 1 , 2 , … , L ,$$

where the coefficients, u_{i,k}, may be random coefficients, Tylor series coefficients, Fourier Series coefficients, Legendre poly coefficients, etc. This results in an input vector, X(t), that is a nonlinear combination of the K dimensions of the measurement vector, Z(t). A normalization of the K dimensions may be necessary to properly generate the high-dimensional input vector, X(t). Because the L-dimensional input vector, X(t), is linearly expanded from the K-dimensional measurement vector, Z(t), the transforming function, q, may be understood to transform the input vector, X(t). The transforming function, q, may be considered to be a sparse, high-dimensional manifold with at least a sparsity represented as L→K.

The applying of an “artificial” data set as a plurality of input vectors, X(t), to a given autoencoder may be shown to allow for use to be made of the backward propagation algorithm to compute an intermediate gradient, ∇_{X}. The intermediate gradient may be used in the expression, Ż(t)=∇_{X}·φ(X(t))·\dot{X}(t), as a way to determine a derivative, Ż(t), of the measurement vector, Z(t). Use may also be made of the backward propagation algorithm to find an encoder transforming function, φ, that generates optimum sparsity over the derivative, Ż(t), of the measurement vector, Z(t). It is known that the sparsity over the derivative, Ż(t), is, at most, K. Ideally, the encoder transforming function, φ, that is found demonstrates a sparsity of less than K over the derivative, Ż(t), of the measurement vector, Z(t). Many physical laws show that, although a K-dimensional measurement vector is not sparse, the derivative, Ż(t), of the measurement vector, Z(t), over time may be much sparser. The learning carried out at the autoencoder is known to have a goal of minimizing a determined value of a standard autoencoder loss function. The minimizing of the value of the standard autoencoder loss function may involve the autoencoder learning to minimize a difference between the input vector, X(t), and the output vector, \hat{X}(t). It may be shown that the learning carried out at the autoencoder is likely to settle at some local minimum in the value of the standard autoencoder loss function. This settling of the learning may be understood to related to determination of the derivative, Ż(t), of the measurement vector, Z(t).

By incorporating an encoder term, [symbol] Ξ, φ [symbol] , into the training target, the autoencoder may more accurately predict the time derivatives of the variables represented in the measurement vector, Z(t), than if the encoder term, [symbol] Ξ, φ [symbol] , was not incorporated. The encoder term, [symbol] Ξ, φ [symbol] , may be expressed as:

$$〈 Ξ , φ 〉 = {arg min}_{Ξ , φ} {‖ {\dot{Z}}^{′} ( t ) - \dot{Z} ( t ) ‖}^{2} = {arg min}_{Ξ , φ} {‖ {∇}_{φ} \cdot \dot{X} ( t ) - Θ ( t ) \cdot Ξ ‖}^{2} .$$

A decoder term, [symbol] Ξ, ψ [symbol] , may also be incorporated in the training target. The decoder term, [symbol] Ξ, ψ [symbol] , may be shown to enhance reconstruction of time derivatives of the input data. The decoder term, [symbol] Ξ, ψ [symbol] , may be expressed as:

$$〈 Ξ , ψ 〉 = {arg min}_{Ξ , ψ} {‖ \dot{\hat{X}} ( t ) - \dot{\hat{{X}^{′}}} ( t ) ‖}^{2} = {arg min}_{Ξ , ψ} {‖ \dot{\hat{X}} ( t ) - {∇}_{ψ} \cdot Θ ( t ) \cdot Ξ ‖}^{2} .$$

A further encoder term, [symbol] φ [symbol] , may be included in the training target. The further encoder term, [symbol] φ [symbol] , may be shown to help the autoencoder to discover the latent variables represented in the measurement vector, Z(t). The further encoder term, [symbol] φ [symbol] , may be omitted if the input dataset is large enough. The value of “large enough” may be determined though experimentation. The further encoder term, [symbol] φ [symbol] , may be expressed as:

$$〈 φ 〉 = {arg min}_{φ} {‖ {Z}^{′} ( t ) - Z ( t ) ‖}^{2} .$$

The encoder term, [symbol] Ξ, φ [symbol] , the decoder term, [symbol] Ξ, ψ [symbol] , and the further encoder term, [symbol] φ [symbol] , may be combined with the standard autoencoder loss function, which may be expressed as:

$$〈 φ , ψ 〉 = {arg min}_{φ , ψ} {‖ X ( t ) - \hat{X} ( t ) ‖}^{2} ,$$

and an l₁ regularization on the sparse coefficients matrix, Ξ, which regularization may be shown to promote sparsity in the sparse coefficient matrix, Ξ, and thus a parsimonious model. An l₁ regularization on the sparse coefficient matrix, Ξ, which may be considered a coefficient term for the training target, may be expressed as

$$〈 Ξ 〉 = {arg min}_{Ξ} \vert Ξ \vert .$$

In summary, a training target, [symbol] φ, ψ, Ξ [symbol] , may be expressed as:

$$\begin{matrix}〈 φ , ψ , Ξ 〉 = {arg min}_{φ , ψ , Ξ} ( {λ}_{1} 〈 φ , ψ 〉 + {λ}_{2} 〈 Ξ , ψ 〉 + {λ}_{3} 〈 Ξ , φ 〉 + {λ}_{4} 〈 φ 〉 + {λ}_{5} 〈 Ξ 〉 ) \\ = {arg min}_{φ , ψ , Ξ} ( {λ}_{1} {‖ X ( t ) - \hat{X} ( t ) ‖}^{2} + {λ}_{2} {‖ \dot{\hat{X}} ( t ) - {∇}_{ψ} \cdot Θ ( t ) \cdot Ξ ‖}^{2} + \\ {λ}_{3} {‖ {∇}_{φ} \cdot \dot{X} ( t ) - Θ ( t ) \cdot Ξ ‖}^{2} + {λ}_{4} {‖ {Z}^{′} ( t ) - Z ( t ) ‖}^{2} + {λ}_{5} \vert Ξ \vert ) ,\end{matrix}$$

where the terms λ₁, λ₂, λ₃, λ₄, λ₅ represent hyperparameters that may be used to provide a relative weighting to individual terms in the training target, [symbol] φ, ψ, Ξ [symbol] .

According to aspects of the present application, on the basis of a plurality of measurements, a deep neural network autoencoder may be used to obtain sparse equations.

Briefly, a method representative of aspects of the present application begins with the SMF 176 (see FIG. 5) receiving of a plurality of measurements. The SMF 176 is assumed to have access to an initial sparse coefficient matrix, Ξ. The processor 290, of the SMF 176, may proceed by forming a measurement vector, Z(t), from the plurality of measurements. An initial library function, Θ(t), may be constructed, from the measurement vector, Z(t), as Θ(t)=[1, Z(t)].

Upon preparing an input data vector, X(t), from a pseudo-random linear span of the measurement vector, the processor 290 may take a multi-phase approach to training a deep neural network autoencoder including an encoder and a decoder.

In a first phase, the processor 290 may train, using the input data vector, X(t), the DNN autoencoder. The output of the DNN autoencoder is a predicted input data vector, \hat{X}(t). The encoder DNN is defined by an encoder transforming function, φ, so that the output of the encoder DNN is a latent vector, Z′(t)=φ(X(t)). The decoder DNN is defined by a decoder transforming function, ψ, so that the output of the decoder DNN is \hat{X}(t)=ψ(Z′(t)). The training of the autoencoder may involve adjusting, using a stochastic gradient descent (SGD) algorithm, the weights in the encoder DNN and the weights in the decoder DNN so as to minimize a standard autoencoder loss function,

$$〈 φ , ψ 〉 = {arg min}_{φ , ψ} {‖ X ( t ) - \hat{X} ( t ) ‖}^{2} .$$

As part of the use of the SGD algorithm to train the autoencoder, the processor 290 may be understood to learn an encoder gradient, ∇_{φ}, and a decoder gradient, ∇_{ψ}.

In a second phase, the processor 290 may then use standard mathematical methods to determine a time derivative, \dot{X}(t), of the input data vector, X(t). The processor 290 may further train the autoencoder using the time derivative, \dot{X}(t), of the input data vector, X(t). The processor 290 may encode the time derivative, \dot{X}(t), of the input data vector, X(t), using the encoder gradient, ∇_{φ}, to give a latent derivative vector, Ż′(t)=∇_{φ}·\dot{X}(t). The processor 290 may decode the latent derivative vector, Ż′(t), using the decoder gradient, ∇_{ψ}, to give a primary predicted derivative of the input data vector, \hat{\dot{X}}(t)=∇_{ψ}·Ż′(t).

In a third phase, in place of the encoder, the processor 290 may use the library function, Θ(t), and the sparse coefficient matrix, Ξ, to obtain a derivative measurement vector, Ż(t)=Θ(t)·Ξ. The processor 290 may decode the derivative measurement vector, Ż(t), using the decoder gradient, ∇_{ψ}, to give a secondary predicted derivative of the input data vector, \hat{\dot{X}}′(t)=∇_{ψ}·Ż(t).

The processor 290 may repeat the three phases while adjusting the encoder transforming function, φ, the decoder transforming function, ψ, and the sparse coefficient matrix, Ξ, to minimize the training target:

$$〈 φ , ψ , Ξ 〉 = {arg min}_{φ , ψ , Ξ} ( {λ}_{1} {‖ X ( t ) - \hat{X} ( t ) ‖}^{2} + {λ}_{2} {‖ \dot{\hat{X}} ( t ) - \dot{\hat{{X}^{′}}} ( t ) ‖}^{2} + {λ}_{3} {‖ {Z}^{′} ( t ) - Z ( t ) ‖}^{2} + {λ}_{4} {‖ {\dot{Z}}^{′} ( t ) - \dot{Z} ( t ) ‖}^{2} + {λ}_{5} \vert Ξ \vert ) .$$

Upon minimizing the training target, the processor 290 may consider the sparse coefficient matrix, Ξ, to be a “trained” sparse coefficient matrix, Ξ. On the basis of the trained sparse coefficient matrix, Ξ, in combination with the library function, Θ(t), the processor 290 may indicate a plurality of sparse equations.

A wireless communication system, especially at the physical layer and at the MAC layer, may be regarded as a candidate for a digital twin system to assist in the establishment and optimization of various configuration parameters for the wireless communication system. For example, the establishment of the various configuration parameters may include assigning a particular density of demodulation reference signals (“DMRSs,” also known as “pilot signals”). The establishment of the various configuration parameters may include deciding on a number of sub-carriers. The establishment of the various configuration parameters may further include determining a sub-carrier spacing. Such configuration parameters, and others, may be tuned and optimized for various deployment scenarios.

In modern wireless system, optimization decisions are generally dependent on measurements and feedback, such as the known channel system index (CSI). In this sense, environmental information may be fed into a network so that the network may act as a kind of digital twin emulator. The best strategies for selecting parameters for such a digital twin emulator may be obtained from many off-time simulations. It is imagined that the off-time simulations are rudimentary for a limited digital twin. In some cases, the strategies for selecting parameters may be simplified or summarized into a number of equations and tables specified in terms of known wireless standards.

Aspects of the present application are related to using the sparse equations in combination with the learning mechanism disclosed hereinbefore to improve, through automation, the procedures for establishment and optimization of various configuration parameters in the physical layer and/or the MAC layer of a wireless communication system.

In particular, along with a large number of sensors to be deployed, the optimization may be accomplished with input received from a plurality of UEs rather than a single, individual UE. Such a cooperative approach may be shown to be preferred because these UEs and the observations made at each UE may be understood to be connected by some underlying physical and natural laws.

Moreover, it is preferable that the learned sparse equations are as generalized as possible. When the learned sparse equations are as generalized as possible, the sparse equations learned in a first scenario (scenario A) may be immediately applied to a second scenario (scenario B). By exchanging and sharing these learned sparse equations, overall network performance may be significantly improved.

The following relates to an example of the known Doppler effect. For centuries, humankind has understood the physical laws governing interdependencies between Doppler frequency shift, moving speed and moving angle. Going beyond understanding the physical laws, it may be shown that aspects of the methods disclosed hereinbefore may be used determine the interdependencies automatically, simply by carrying out an analysis of a series of measurements of frequency shift, moving speed and moving angle.

Furthermore, it will demonstrated, hereinafter, that aspects of the present application may be extended to determine the interdependencies in more complicated situations, such as situations that involve two receivers and a three-dimensional space, rather than a two-dimensional space. The learned equations, and the deep neural network autoencoder that is a by-product of the learned equations, may be considered to be as generalized as possible, such that the learned equations and the deep neural network autoencoder may be applied to other, distinct, scenarios.

The Doppler effect is a name given to the change, Δf, in frequency of a wave experienced by an observer when the observer is moving relative to the source of the wave. In classical physics, where the speeds of the source and the receiver relative to the medium are lower than the velocity of waves in the medium, the relationship between observed frequency, f, and emitted frequency, f₀, is given by:

$$f = ( \frac{c \pm {v}_{r}}{c \pm {v}_{s}} ) {f}_{0} ,$$

where the variable, c, represents a wave propagation speed for waves in the medium. A receiver velocity, vᵣ, of the receiver relative to the medium is added to the wave propagation speed, c, if the receiver is moving towards the source. The receiver velocity, vᵣ, is subtracted from the wave propagation speed, c, if the receiver is moving away from the source. A source velocity, vₛ, of the source relative to the medium is added to the wave propagation speed, c, if the source is moving away from the receiver. The source velocity, vₛ, is subtracted from the wave propagation speed, c, if the source is moving towards the receiver.

If the receiver velocity, vᵣ, and the source velocity, vₛ, are small compared to the wave propagation speed, c, the difference, Δf, between observed frequency, f, and emitted frequency, f₀, may be approximately by:

$$Δ f = \frac{Δ v}{c} {f}_{0} , \qquad ( 1 )$$

where Δf=f−f₀; and Δv=vₛ−vᵣ represents a relative velocity of the receiver relative to the source. The relative velocity, Δv, is positive when the source and the receiver are moving towards each other.

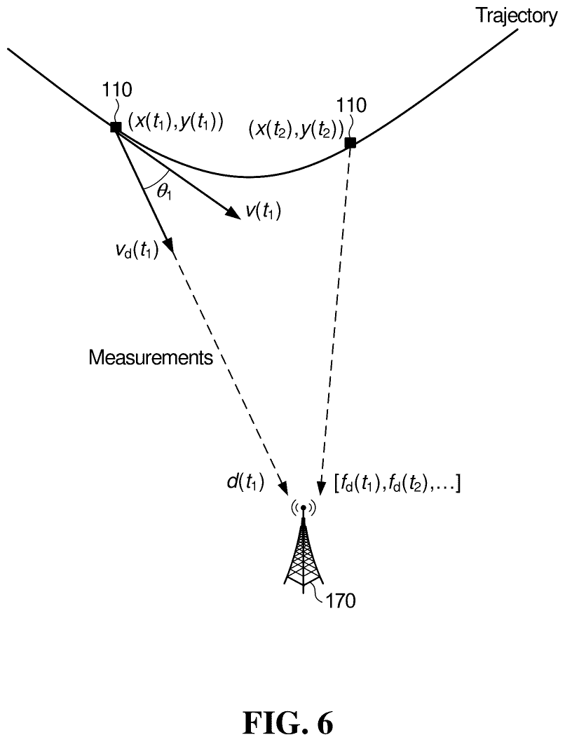

FIG. 6 illustrates a context for obtaining measurements of a moving UE 110. The UE 110 is illustrated in a first location at a first time, t₁. The UE 110 is also illustrated in a second location at a second time, t₂. At the first time, the UE 110 is associated with a first velocity vector, v(t₁), and a first straight-line distance, d(t₁), to a TRP 170. The straight-line to the TRP 170 may be understood to form an angle, θ, with the first velocity vector.

The relationship presented hereinbefore as equation (1) may be restated for a frequency difference, Δf, also reference herein as a Doppler shift, f_{d}(t), for the context illustrated in FIG. 6, as:

$${f}_{d} ( {t}_{i} ) = \frac{f}{c} * v ( {t}_{i} ) * cos {θ}_{i} . \qquad ( 2 )$$

It is supposed that raw data is available that provides an indication of the position of the UE 110. The Doppler frequency may be represented as a three-element vector, [f_{d}(t), x(t), y(t)]. On the basis of the raw data, values may be determined at each time, t, for three variables: the distance between the UE 110 and the TRP 170; the speed of the UE 110 relative to the TRP 170; and the acceleration of the UE 110 relative to the TRP 170. The model may then be trained with these values with a desire to discover the interdependencies among the variables, the irrelevance among variables and any non-linearity with time from t_{N} to t_{N+1}.

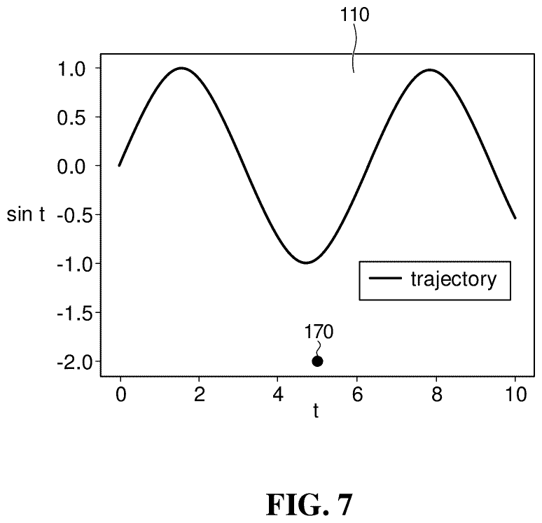

Assuming that the UE 110 moves, as illustrated in FIG. 7, along a sin t trajectory from t=0 to t=10, equation (2) may be used to obtain measurement data, [f_{d}(t), x(t), y(t)], where x(t)=t and y(t)=sin t.

Measurement data, [f_{d}(t), x(t), y(t)], representative of the position of the UE 110, as the UE 110 follows the trajectory illustrated in FIG. 7, may be obtained with a spacing of Δt=0.02 to, thereby, obtain 500 samples in the time span from t=0 to t=10. Each sample may be used when determining a value for an expression for the measurement vector:

$$Z ( t ) = [ {f}_{d} ( t ) , x ( t ) , y ( t ) , d ( t ) , \dot{d} ( t ) , \ddot{d} ( t ) ] ,$$

where d(t) represents a distance between the UE 110 and the TRP 170; \dot{d}(t) represents a velocity, v_{d}(t), of the UE 110 toward the TRP 170; and \ddot{d}(t) represents an acceleration, a_{d}(t), of the UE 110 toward the TRP 170. Each sample may also be used when determining a value for the derivative, Ż(t), of the measurement vector, Z(t). An input data vector, X(t)=[x₁(t), x₂(t), . . . , x_{L}(t)], may be prepared from a pseudo-random linear span of the measurement vector, Z(t), using an expression:

$${x}_{l} ( t ) = {u}_{l , 1} \cdot {f}_{d} ( t ) + {u}_{l , 2} \cdot x ( t ) + {u}_{l , 3} \cdot y ( t ) + {u}_{l , 4} \cdot d ( t ) + {u}_{l , 5} \cdot \dot{d} ( t ) + {u}_{l , 6} \cdot \ddot{d} ( t ) , l = 1 , 2 … L .$$

where there is a distinct network weight, u_{l,i}, associated with each term.

Inside the autoencoder, a library function, Θ(t), may be constructed as Θ(t)=[1, Z(t)]=[1, f_{d}(t), x(t), y(t), d(t), \dot{d}(t), \dot{d}(t)].

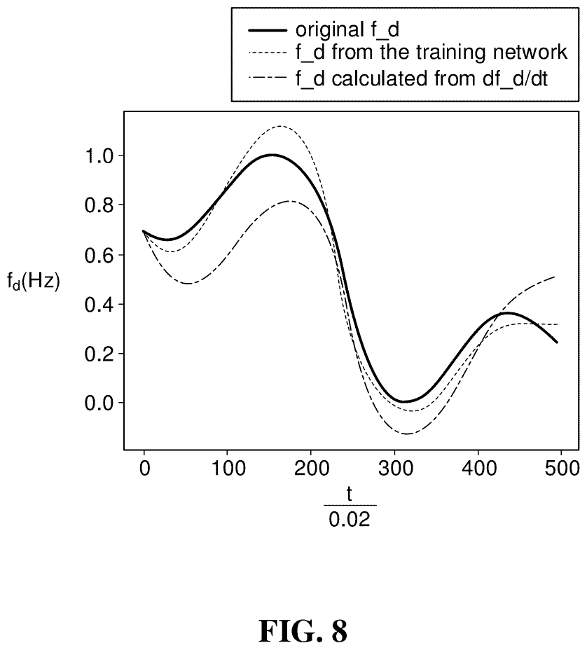

Following the training procedure described hereinbefore, it may be observed that a plurality of models may be learned using the single set of training data. The performance of each model is expected to differ from the other models. It may be considered that variability among the models occurs due to initialization of the network weights that are used to prepare the input vector, X(t), from the measurement vector, Z(t). It follows that, even for the same set of hyperparameters, λ₁, λ₂, λ₃, λ₄, λ₅, it makes sense to train several models. Results produced by determining a predicted Doppler shift, f_{d}, using one of the models are shown in FIG. 8 relative to the original Doppler shift, f_{d}. As expected, the model is able to accurately predict a Doppler shift, f_{d}, and a time derivative, \dot{f}_{d}, of the Doppler shift. A predicted Doppler shift, f_{d}, may be determined from the time derivative of the Doppler shift, \dot{f}_{d}, using the formula:

$${f}_{d} ( {t}_{i + 1} ) = {f}_{d} ( {t}_{i} ) + Δ t * {\dot{f}}_{d} ( {t}_{i} ) .$$

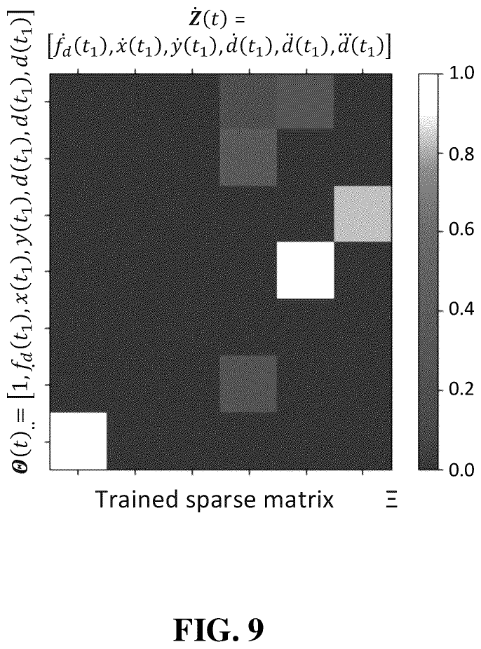

It may be shown that the trained sparse coefficient matrix, Ξ, can be used to understand the dynamics of the system. From the sparse coefficient matrix, Ξ, illustrated in FIG. 9, it can be inferred that the predicted Doppler shift, f_{d}, is related to the velocity, \dot{d}, which is consistent with the equation:

$${f}_{d} ( {t}_{i} ) = \frac{f}{c} * \dot{d} ( {t}_{i} ) .$$

It can also be inferred that there is a relationship that relates the time derivative, \dot{f}_{d}, of the predicted Doppler shift, f_{d}, to the acceleration, \ddot{d}. This relationship may be seen as consistent with the equation:

$${\dot{f}}_{d} ( {t}_{i} ) = \frac{f}{c} * \ddot{d} ( {t}_{i} ) .$$

Moreover, from the sparse coefficient matrix, Ξ, illustrated in FIG. 9, it can also be inferred that the predicted Doppler shift, f_{d}, has nothing to do with time derivatives of the positions, \dot{x}, \dot{y}, as may be expected.

The sparse coefficient matrix, Ξ, may be understood to represent an extent to which the model has learned about relationships between variables. Such learning may be shown to enable the model to generalize.

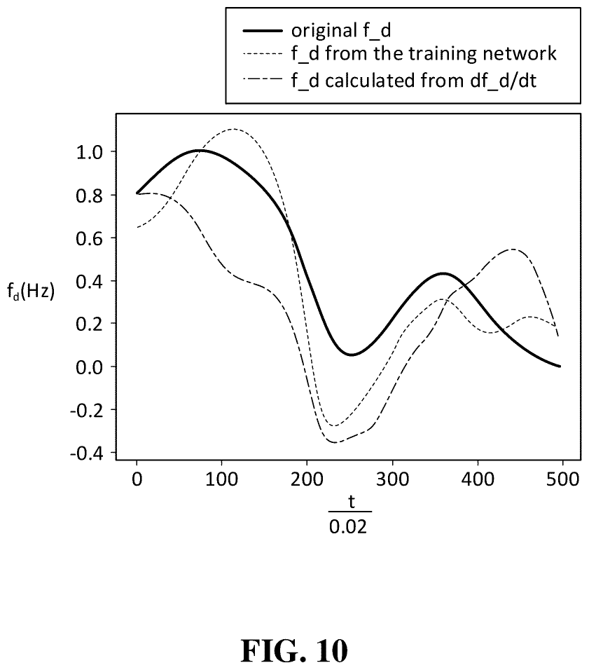

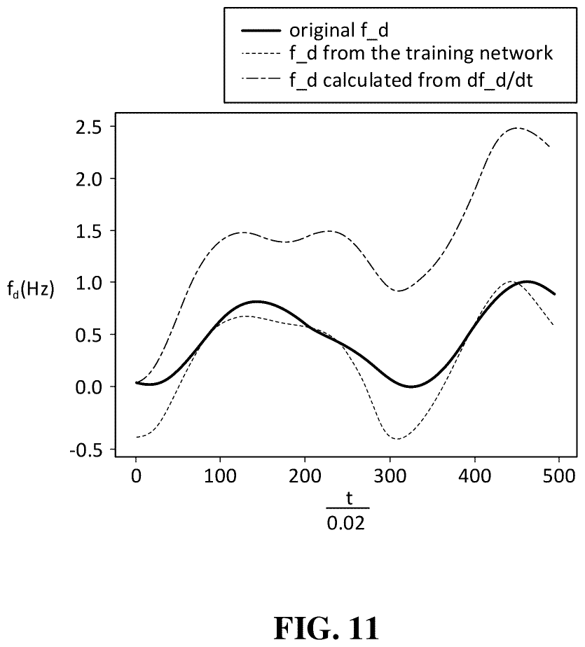

To test the whether the model that has been developed may be generalized, the model, learned using one trajectory, may be tested for other trajectories. Results are illustrated in FIGS. 10 and 11 that have been obtained by applying the learned model to two other trajectories. The model trained on historical data (the single UE 110 in FIG. 7) may be shown to be able to predict future events that are not represented in the training set.

The model demonstrates the capacity to capture the dynamics of the system. It may be shown that the above example may be extended to a more complicated situation: two UEs 110 following distinct trajectories. The first UE 110A moves along a first trajectory defined as x₁=t, y₁=sin t from t=0 to t=10, and the second UE 110B moves along a second trajectory defined as x₂=sin t, y₂=t from t=0 to t=10. Raw measurements [f_{d}_{₁}(t), x₁(t), y₁(t)] and [f_{d}_{₂}(t), x₂(t), y₂(t)] may be generated using the Doppler formula, such that values for the measurement vectors, Z₁(t)=[f_{d}_{₁}(t), x₁(t), y₁(t), d₁(t), \dot{d}₁(t), \ddot{d}₁(t)] and Z₂(t)=[f_{d}_{₂}(t), x₂(t), y₂(t), d₂(t), \dot{d}₂(t), \dot{d}₁(t)] may be obtained. In addition, values for derivatives, Ż₁(t) and Ż₂(t), of respective measurement vectors, Z₁(t) and Z₂(t), may be obtained in a manner that is similar to manner in the example presented hereinbefore. The measurement vectors, Z₁(t) and Z₂(t), may be combined via simple concatenation:

$$Z ( t ) = [ \begin{matrix}{Z}_{1} ( t ) \\ {Z}_{2} ( t )\end{matrix} ] , \dot{Z} ( t ) = [ \begin{matrix}{\dot{Z}}_{1} ( t ) \\ {\dot{Z}}_{2} ( t )\end{matrix} ] .$$

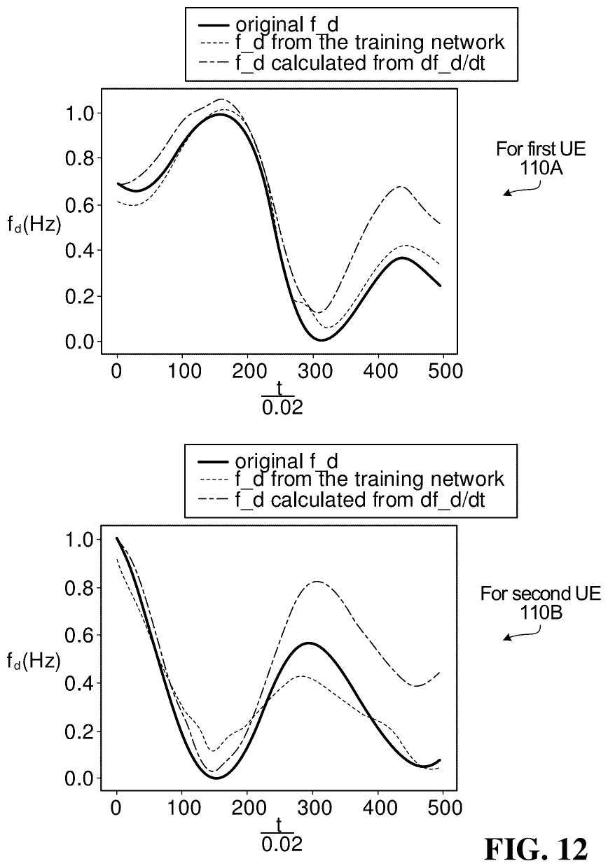

Similar to the example presented hereinbefore, input data, X(t), may be determined from a pseudo-random linear span of the measurement vector, Z(t), and a library function, Θ(t), may be constructed as Θ(t)=[1, Z(t)]. Results for each UE 110A, 110B are illustrated in FIG. 12.

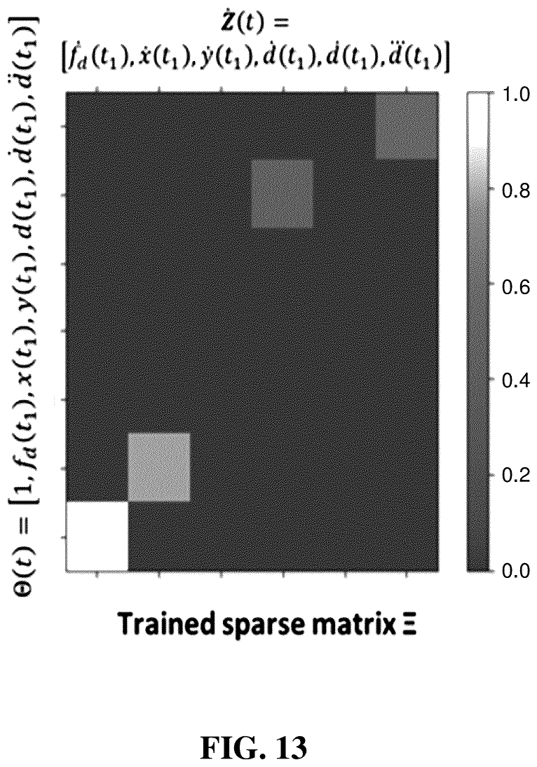

FIG. 13 illustrates a trained sparse coefficient matrix, Ξ, which may be characterized as sparse and informative because the trained sparse coefficient matrix, Ξ, illustrated in FIG. 13, illustrates that the predicted Doppler shift, f_{d}, is related to the velocity, \dot{d}. The trained matrix, Ξ, illustrated in FIG. 13, also illustrates that the time derivative, \dot{f}_{d}, of the predicted Doppler shift, f_{d}, is related to the acceleration, \ddot{d}. From the trained matrix, Ξ, illustrated in FIG. 13, it can be inferred that the predicted Doppler shift, f_{d}, has nothing to do with time derivatives of the positions, \dot{x}, \dot{y}, as may be expected.

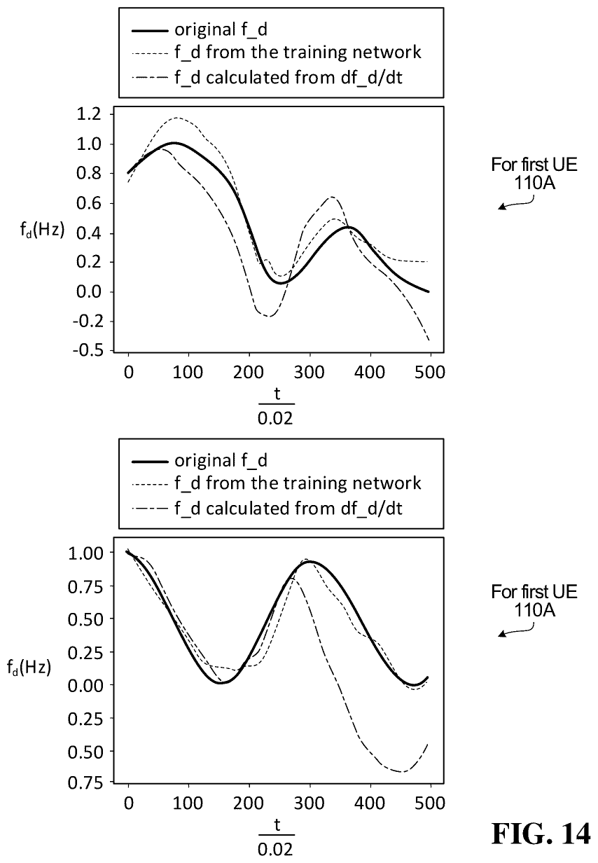

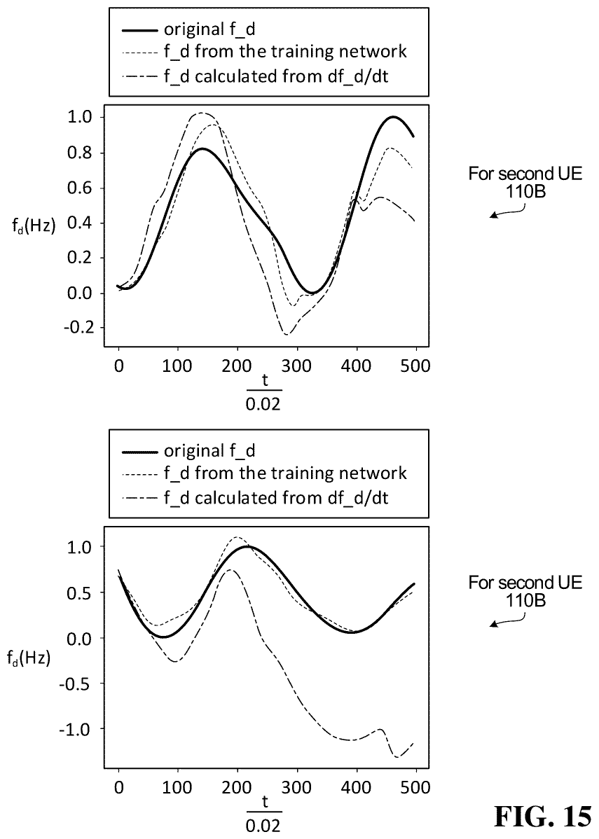

The model may be tested in the context of trajectories that differ from the trajectories for each user, on which the model was trained. Results from this test, illustrated in FIGS. 14 and 15 may be understood to be encouraging.

In a further test, models have been trained for two users over distinct trajectories with random coefficients. The further test may be shown to allow the models to vary more.

The success of the three test suggests that it is feasible to simultaneously discover sparse dynamic models and coordinates using algorithms representative of aspects of the present application. Cause-and-effect relationships may be discovered between some variables and irrelevance may be discovered between other variables. Time derivatives obtained from trained models can be used to predict future events. It follows that learning general dynamic sparse models, as representative of aspects of the present application, may have application in wireless system.

It can be shown that Doppler shift may be exploited for data transmission in wireless system, especially for 5G applications. 5G communication is known to employ relatively high radio frequencies, such as 5 GHz, 27 GHz and 54 GHz, to carry data from a UE 110 to a TRP 170 and on to an endpoint for the data. At such high frequencies, even if the source or the receiver is moving at a relatively low speed, the Doppler shift may be shown to be significant.

Another piece of information received at the TRP 170 is power.

A free-space path loss formula may be derived from a transmission formula. Free-space path loss may be shown to be a loss factor in the transmission formula and may be dependent upon distance and wavelength. In other words, assuming that the antennas of the transmitter and receiver are isotropic and have no directivity, a ratio of power transmitted to power received may be understood to be representative of a free-space path loss. Since the frequency, f, of a given radio wave is equal to the speed of light, c, divided by the wavelength of the given radio wave, the path loss, P, can be expressed in terms of frequency:

$$P = {( \frac{4 π df}{c} )}^{2}$$

which may be understood to take into account a distance, d, between transmitting and receiving antennas and a carrier frequency, f.

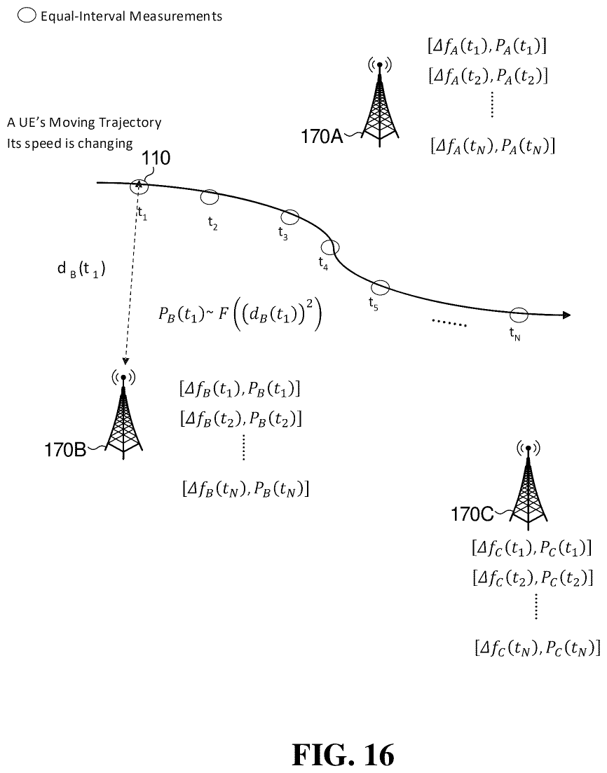

FIG. 16 illustrates a scenario wherein a UE 110 is moving along a trajectory while sending information to, or receiving information from, three nearby TRPs: a first TRP 170A; a second TRP 170B; and a third TRP 170C. Each TRP 170 is illustrated as having obtained measurement data for time instances labelled t₁, t₂, t₃, t₄, t₅, . . . , t_{N}. The measurement data includes a frequency difference, Δf(tᵢ), and a power, P(tᵢ). It is known that three received powers, [P_{A}(tᵢ), P_{B}(tᵢ), P_{C}(tᵢ)], from antennas that are not in a line, may be used to determine a position for the UE 110. It is known that the frequency differences, [Δf_{A}(tᵢ), Δf_{B}(tᵢ), Δf_{c}(tᵢ)], are more or less related to the Doppler effect. The algorithm representative of aspects of the present application may be used to learn relationships, if any, between these measurements. As discussed hereinbefore, the measurements may also be referred to as “variables.”

The measurement vector may be expressed as:

$$Z ( t ) = [ \begin{matrix}Δ {f}_{A} ( t ) , Δ {f}_{B} ( t ) , Δ {f}_{C} ( t ) , {P}_{A} ( t ) , {P}_{B} ( t ) , {P}_{C} ( t ) , \\ Δ {\dot{f}}_{A} ( t ) , Δ {\dot{f}}_{B} ( t ) , Δ {\dot{f}}_{A} ( t ) , {\dot{P}}_{A} ( t ) , {\dot{P}}_{B} ( t ) , {\dot{P}}_{C} ( t ) , \\ Δ {\ddot{f}}_{A} ( t ) , Δ {\ddot{f}}_{B} ( t ) , Δ {\ddot{f}}_{C} ( t ) , {\ddot{P}}_{A} ( t ) , {\ddot{P}}_{B} ( t ) , {\ddot{P}}_{C} ( t )\end{matrix} ] .$$

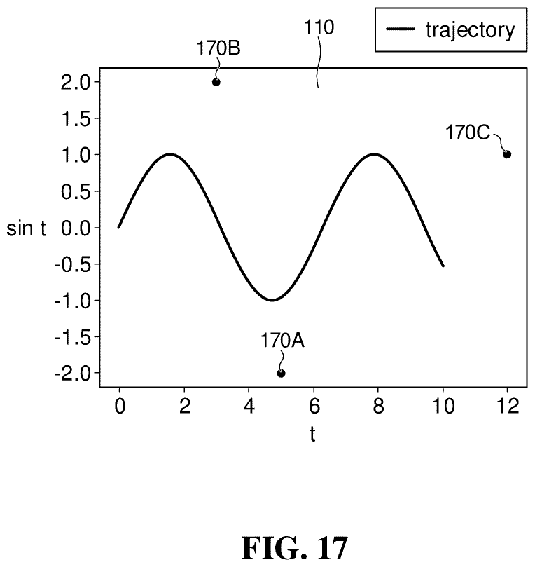

The problem of locating the UE 110 on the basis of measurements made at three TRPS 170 may benefit from a shift in perspective. It is assumed that the trajectory of the UE 110 is known, as illustrated in FIG. 17, wherein the UE 110 moves along a sin t trajectory from t=0 to t=10 among three nearby TRPs: a first TRP 170A; a second TRP 170B; and a third TRP 170C. Measurement data may be obtained for the position, [x(t), y(t)], with a spacing of Δt=0.02 to obtain 500 samples, where x(t)=t and y(t)=sin t.

A distance between the UE 110 and each TRP 170 may be determined at every time instance, as well as a velocity and an acceleration toward each TRP 170. At each TRP 170, a predicted Doppler shift, f_{d}(t), may be determined from:

$${f}_{d} ( {t}_{i} ) = \frac{f}{c} * \dot{d} ( {t}_{i} )$$

and a path loss may be determined from:

$$P ( {t}_{i} ) = {( \frac{4 π f}{c} )}^{2} * {d ( {t}_{i} )}^{2} .$$

For the first TRP 170, a set of variables may be expressed as a measurement vector in the form Z_{A}(t)=[f_{d}_{_{A}}(t), x(t), y(t), d_{A}(t), \dot{d}_{A}(t), \ddot{d}_{A}(t), P_{A}(t)]. Similar to examples presented hereinbefore, the individual measurement vectors, Z_{A}(t), Z_{B}(t), Z_{C}(t), may be combined using concatenation to form an overall measurement vector:

$$Z ( t ) = [ \begin{matrix}{Z}_{A} ( t ) \\ {Z}_{B} ( t ) \\ {Z}_{C} ( t )\end{matrix} ]$$

and the respective derivatives, Ż_{A}(t), Ż_{B}(t), Ż_{C}(t), may also be combined using concatenation to form an overall measurement derivative vector:

$$\dot{Z} ( t ) = [ \begin{matrix}{\dot{Z}}_{A} ( t ) \\ {\dot{Z}}_{B} ( t ) \\ {Z}_{C} ( t )\end{matrix} ] .$$

An input data vector, X(t), may be constructed from pseudo-random linear span of the overall measurement vector, Z(t):

$${x}_{l} ( {t}_{1} ) = {u}_{l , 1} \cdot {f}_{d} ( {t}_{1} ) + {u}_{l , 2} \cdot x ( {t}_{1} ) + {u}_{l , 3} \cdot y ( {t}_{1} ) + {u}_{l , 4} \cdot d ( {t}_{1} ) + {u}_{l , 5} \cdot \dot{d} ( {t}_{1} ) + {u}_{l , 6} \cdot \ddot{d} ( {t}_{1} ) + {u}_{l , 7} \cdot P ( {t}_{1} ) , l = 1 , 2 … L$$

and an input data derivative vector, \dot{X}(t), may be similarly constructed from a pseudo-random linear span of the overall measurement derivative vector, Ż(t). A library function, Θ(t), may be constructed with second-order polynomials due to the nature of this system:

$$Θ ( t ) = [ 1 , {f}_{d} ( t ) , x ( t ) , y ( t ) , d ( t ) , \dot{d} ( t ) , \ddot{d} ( t ) , P , {f}_{d}^{2} , {f}_{d} * x , {f}_{d} * y , {f}_{d} * d , {f}_{d} * {v}_{d} , {f}_{d} * {a}_{d} , {f}_{d} * P , {x}^{2} , … … , {P}^{2} ] .$$

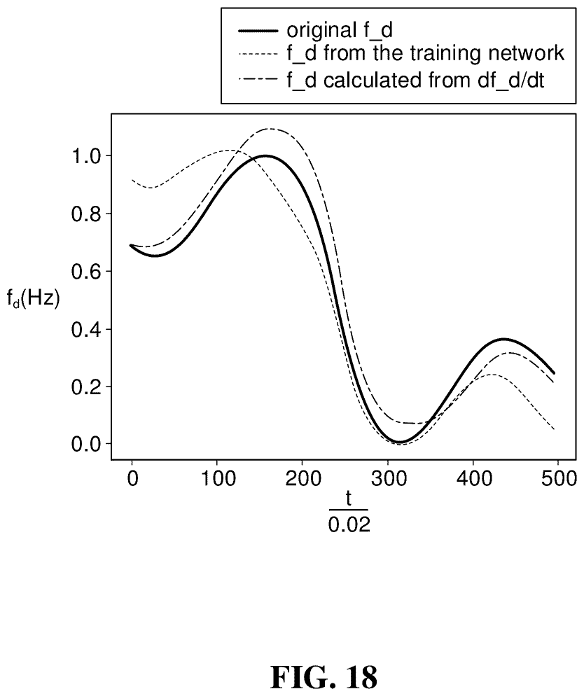

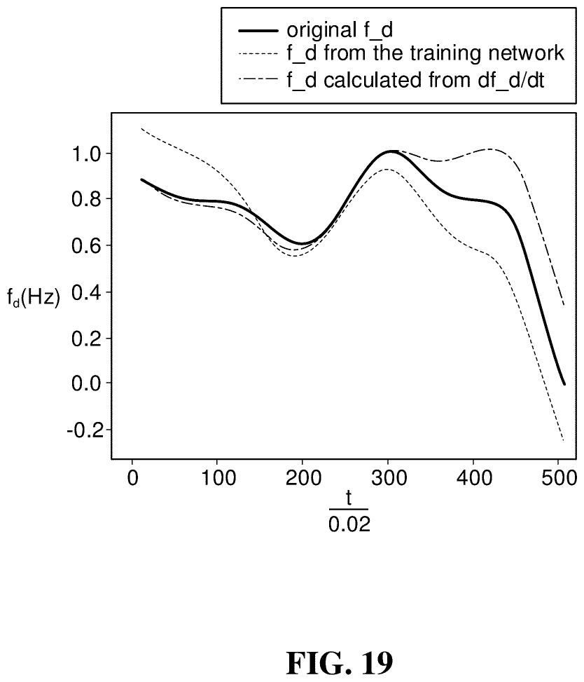

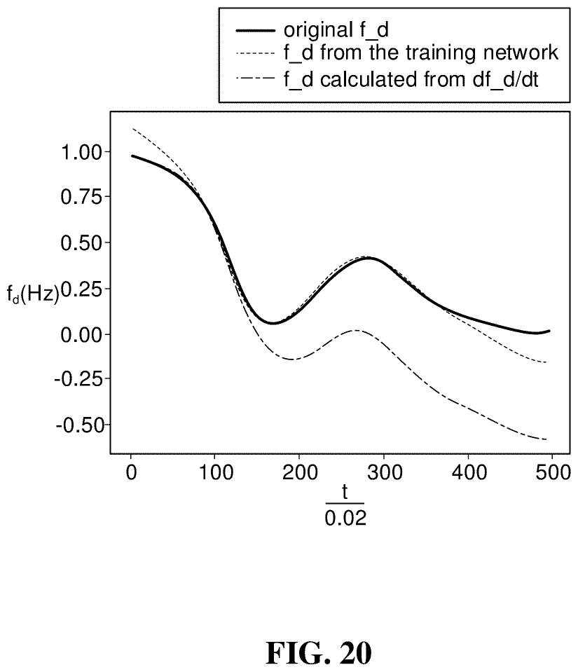

Several models may be trained with care taken while tuning parameters. Results of a preferred model are illustrated in FIGS. 18, 19 and 20. In particular, FIG. 18 illustrates results for the preferred model for the first TRP 170A, FIG. 19 illustrates results for the preferred model for the second TRP 170B and FIG. 20 illustrates results for the preferred model for the third TRP 170C. The model may be understood to predict frequencies and time derivatives of the frequencies with an acceptable accuracy. The trained sparse coefficient matrix, Ξ, may be understood to be sparse and informative. Even though the sparse coefficient matrix, Ξ, does not express the exact relationship between variables, it provides information about the relevance and irrelevance between variables.

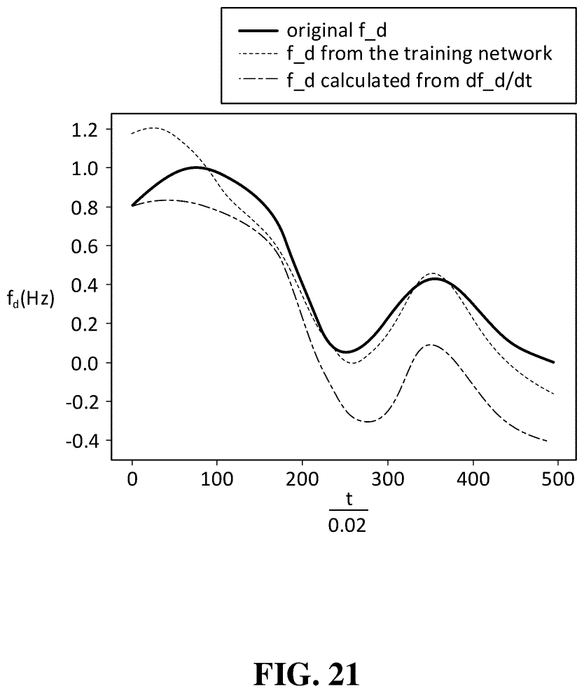

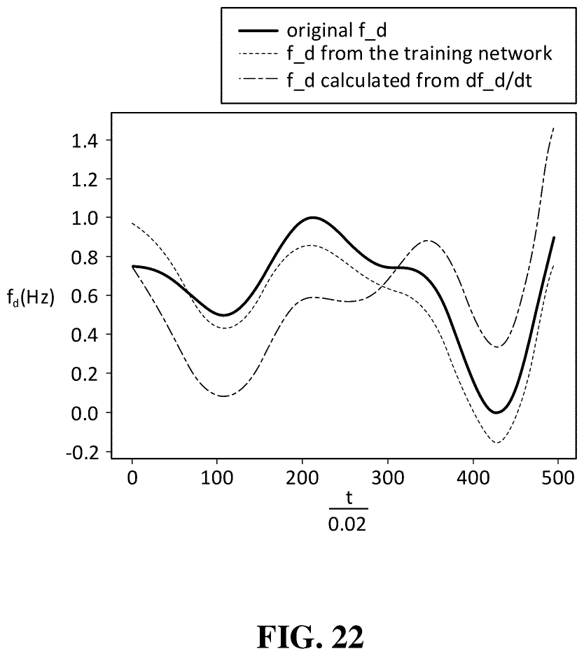

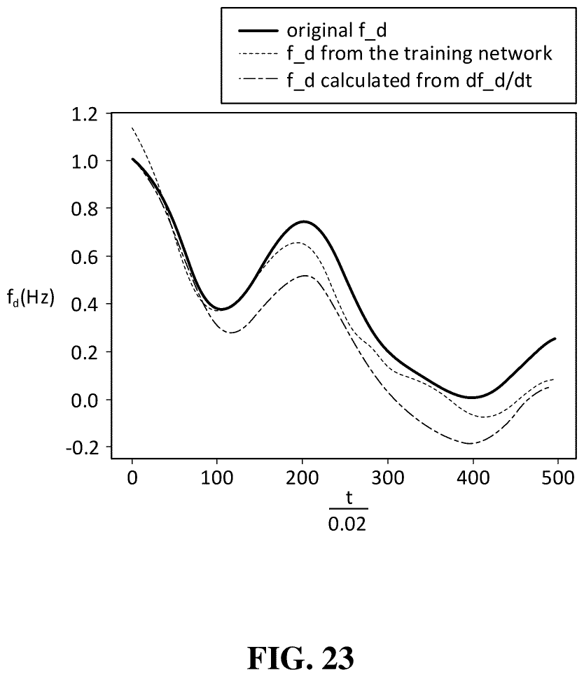

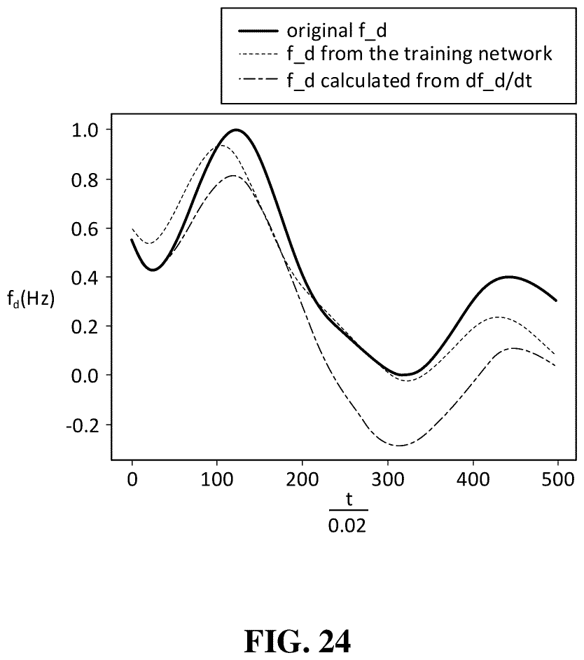

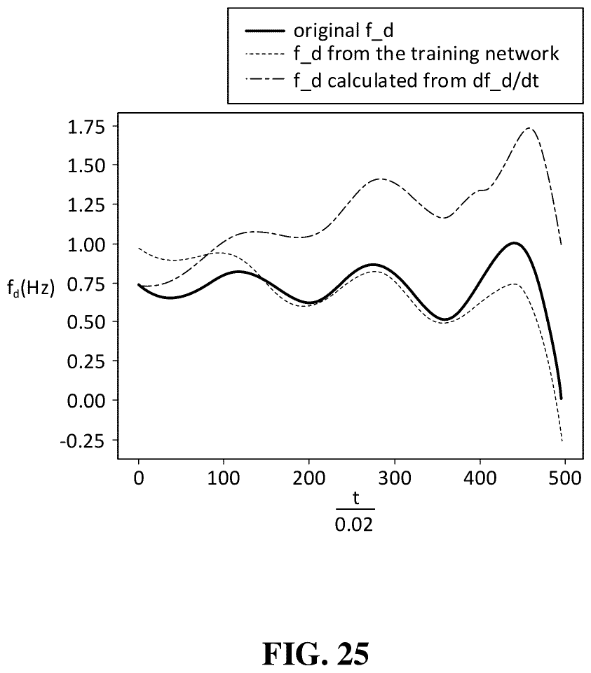

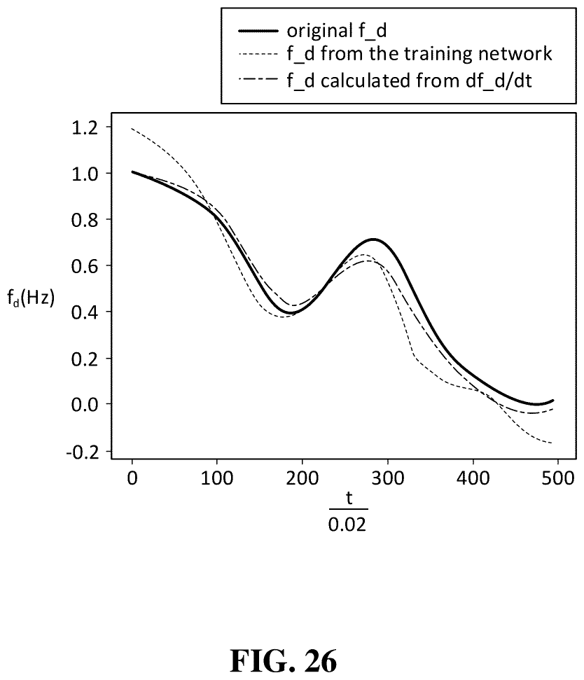

To test whether the preferred model may be generalized, the preferred model may be tested on an unknown trajectory and the preferred model may be test for new locations for the three TRPs 170. Results of applying the preferred model to the unknown trajectory are illustrated in FIGS. 21, 22 and 23. In particular, FIG. 21 illustrates unknown trajectory results for the preferred model for the first TRP 170A, FIG. 22 illustrates unknown trajectory results for the preferred model for the second TRP 170B and FIG. 23 illustrates unknown trajectory results for the preferred model for the third TRP 170C. Results of applying the preferred model to the new locations are illustrated in FIGS. 24, 25 and 26. In particular, FIG. 24 illustrates new locations results for the preferred model for the first TRP 170A, FIG. 25 illustrates new locations results for the preferred model for the second TRP 170B and FIG. 26 illustrates new locations results for the preferred model for the third TRP 170C.

In the examples presented hereinbefore, it is assumed, when generating data, that there exist no obstacles between the UE 110 and the TRP 170. In practice, most of the time, a received power will be reduced in a scenario with propagation obstructed by a building relative to a received power for a scenario with propagation in free space.

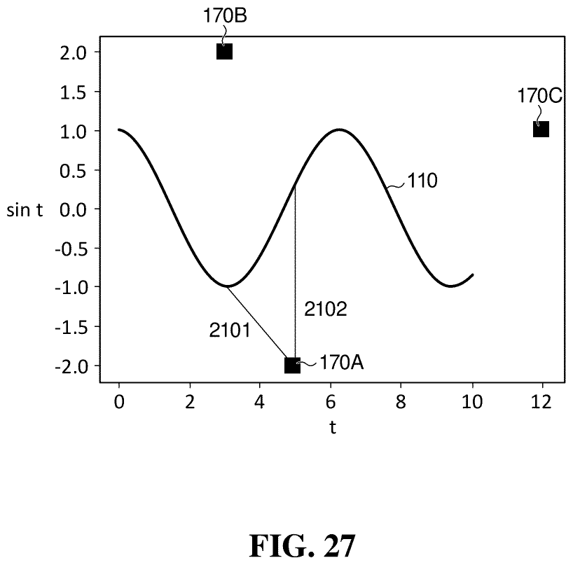

It is assumed that the trajectory of the UE 110 is known, as illustrated in FIG. 27, wherein a UE 110 moves along a sin t trajectory from t=0 to t=10 among three nearby TRPs: a first TRP 170A; a second TRP 170B; and a third TRP 170C. Measurement data may be obtained for the position, [x(t), y(t)], with a spacing of Δt=0.02 to obtain 500 samples, where x(t)=t and y(t)=sin t. The scenario of FIG. 27 may be adjusted to test aspects of the present application when propagation is obstructed by a building. The adjusting may involve reducing values of the powers received, by the first TRP 170A, when the UE 110 is between a first line 2101 and a second line 2102 in FIG. 27. The reduction of the values of the received powers may be understood to simulate buildings obstructing a transmission, to the first TRP 170A, from the UE 110.

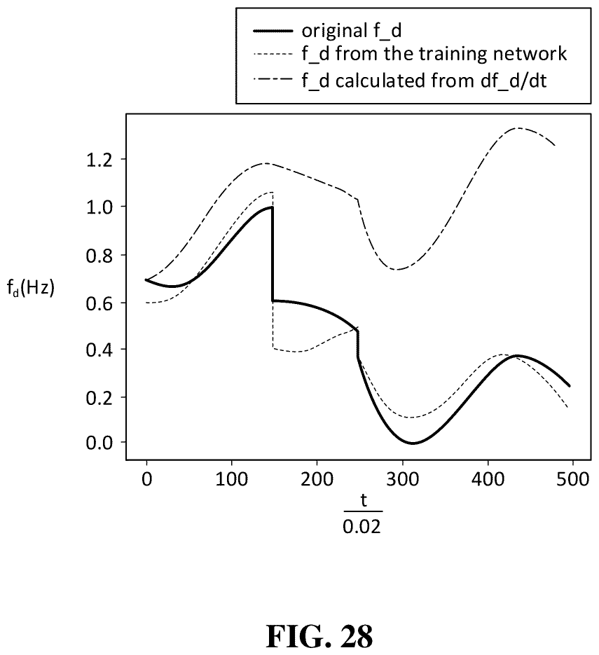

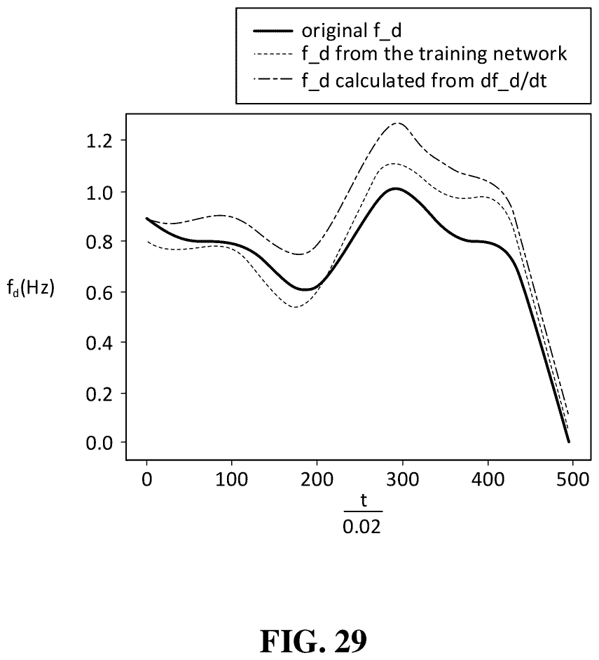

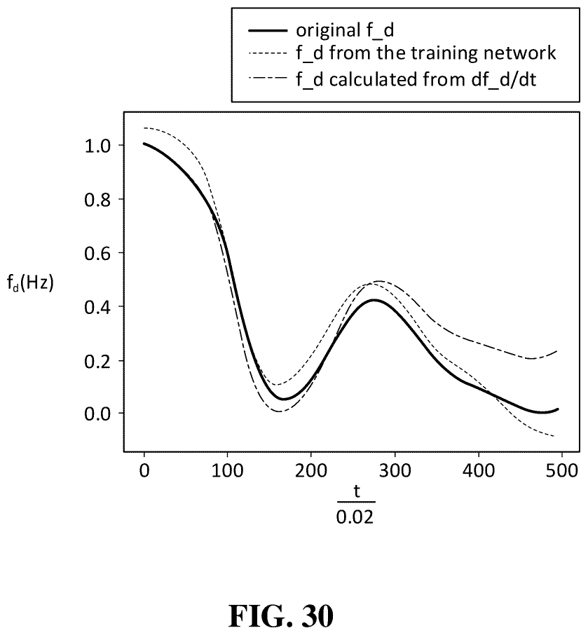

The rest of the data generation procedure is similar to the example above. As discussed hereinbefore, several models may be trained after tuning the parameters. Results of applying a preferred model in the context of shadowed data are illustrated in FIGS. 28, 29 and 30. In particular, FIG. 28 illustrates shadowed results for the preferred model for the first TRP 170A, FIG. 29 illustrates shadowed results for the preferred model for the second TRP 170B and FIG. 30 illustrates shadowed results for the preferred model for the third TRP 170C. FIGS. 28, 29 and 30 illustrate that the overall performance of the model is excellent even though the shadow in data generation has negative impact on some of the results.

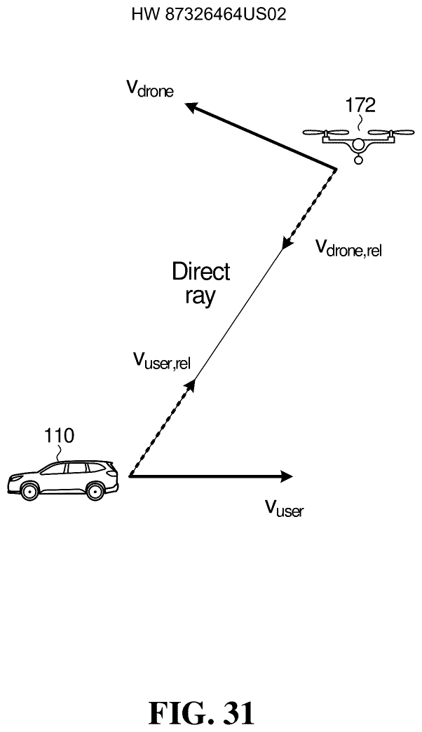

Aspects of the present application may be extended from two-dimensional scenarios, that have been discussed to this point, to three-dimensional scenarios. An example three-dimensional scenario is illustrated in FIG. 31 to include a UE 110, implemented as an automobile, and an NT-TRP 172, implemented as a drone. It is expected that drone-based TRPs will be introduced for wireless communication according to 5G standards and sixth-generation (6G) standards.

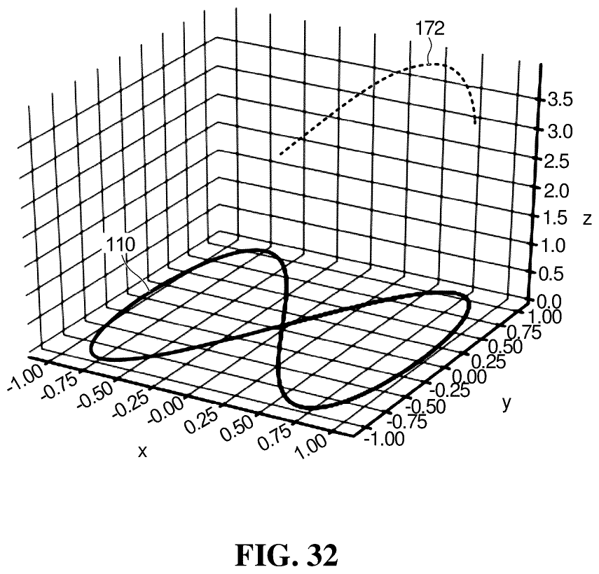

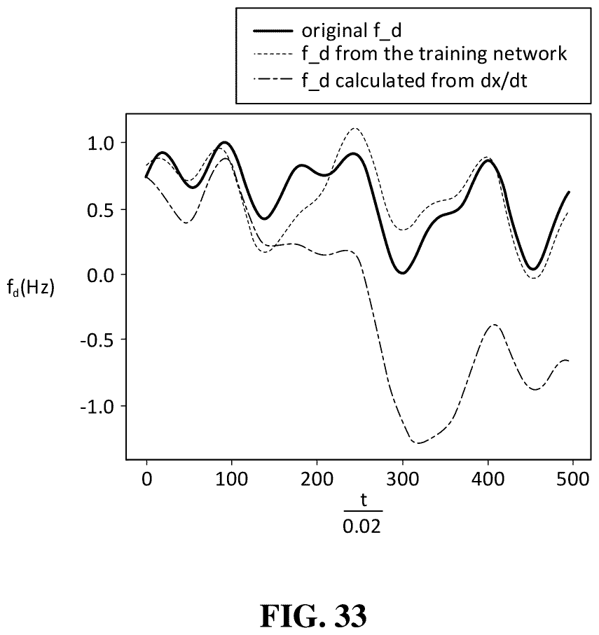

The UE 110 in motion and the NT-TRP 172 in motion may be understood to have respective trajectories, as illustrated in FIG. 32. It follows that measurements are to be taken while the UE 110 and the NT-TRP 172 follow their respective trajectories. FIG. 33 illustrates results for a preferred model for the NT-TRP 172 in FIG. 32 in accordance with aspects of the present application.

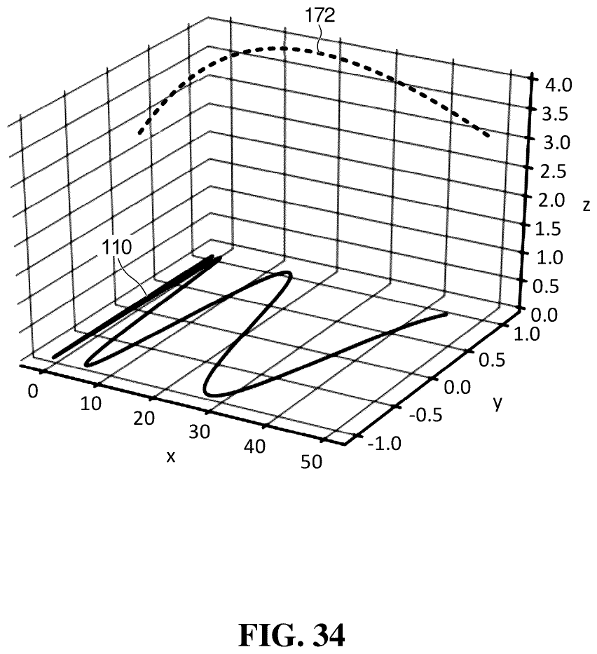

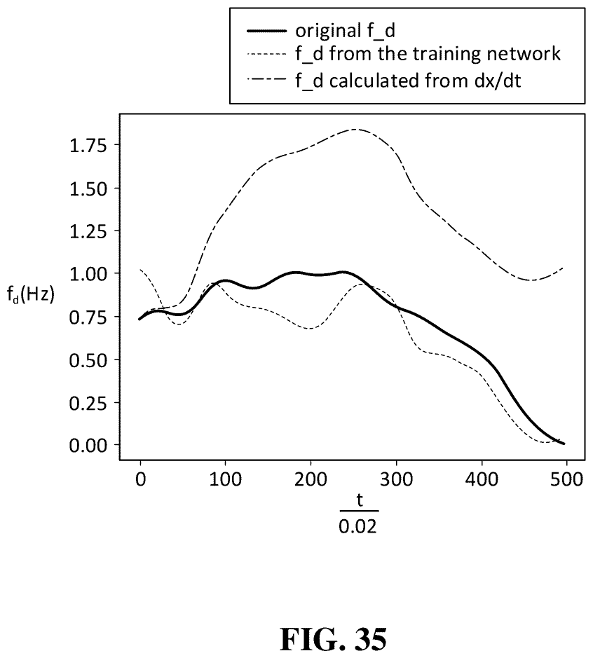

FIG. 34 illustrates respective trajectories for a UE 110 in motion and a NT-TRP 172 in motion and FIG. 35 illustrates results for a preferred model for the NT-TRP 172 in FIG. 34 in accordance with aspects of the present application.

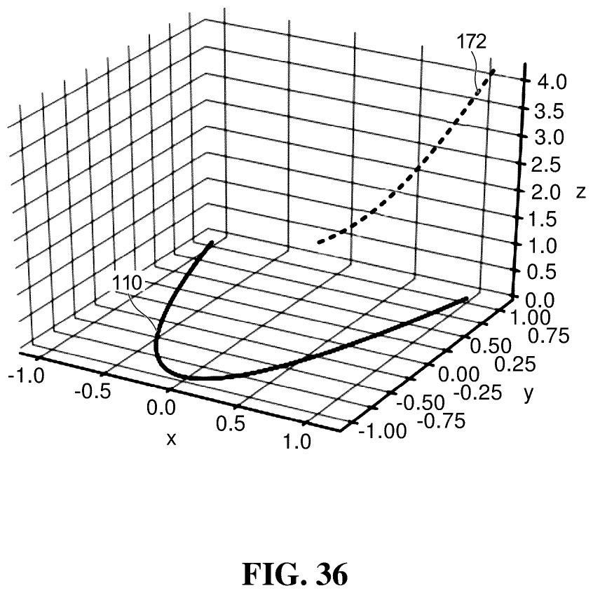

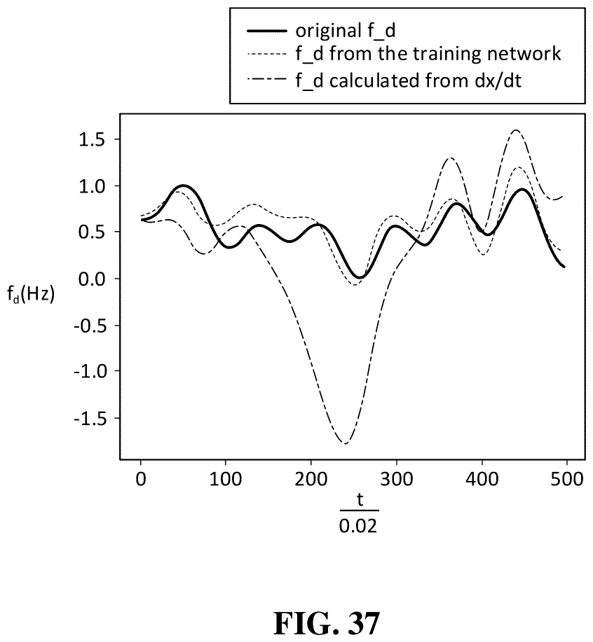

FIG. 36 illustrates respective trajectories for a UE 110 in motion and a NT-TRP 172 in motion and FIG. 37 illustrates results for a preferred model for the NT-TRP 172 in FIG. 36 in accordance with aspects of the present application.

In summary, it is known that a digital twin can be represented by a dynamic equation. Aspects of the present application may be shown to relate to data-driven ways to learn sparse coefficients of a linear dynamic equation.

A digital twin may be seen as an emulator of an environment in sensing communication. Multiple modular and high-dimensional true physical environments may be efficiently represented in linear sparse dynamic equations. Conveniently, redundancy among sensors (dimensions) may be identified. Removal of such redundancy may be shown to allow for a saving of various resources, such as bandwidth resources, storage resources and computation resources. The recognized redundancy may also allow for a cross-check across distinct sensors. A digital twin may be used as a predictor of a wireless environment for multiple users. It follows that scheduling and physical configuration parameterization may be carried out on a predictive version of the wireless environment instead of a current version of the wireless environment, thereby reducing latency.

A sparse equation is usually (as described in the present application) a dynamic equation. That is, the output of the sparse dynamic equation is also dynamic with perspective to time offset (Δt), frequency offset (Δf), space offset (Δdistance), or the like.

The acquired dynamic equation may indicate information regarding an extent to which a dynamic (ΔA) of a parameter, A, changes with respect to a generic dimension, Δd, among a plurality of dimensions, which plurality may include time, space, frequency, etc. From this information, it may be concluded that there may be no need to directly measure the parameter, A.

The acquired dynamic equation may indicate information regarding an extent to which another dynamic, ΔA/Δd, is a function of other parameters. That is, the information may indicate that

$$\frac{Δ A}{Δ d} = F ( B , C , D , θ ) .$$

Such information may allow for measuring B, C and D, instead of directly the parameter, A. The measured B, C and D may be input them into F (B, C, D, θ) to obtain ΔA/Δd. Sometimes, it is much more expensive, or impossible, to directly measure the parameter, A.

The acquired dynamic equation may indicate a scale for ΔA/Δd. The information may indicate a resolution of the parameter, A, over the dimension, d. A sparse equation, obtained according to aspects of the present application, may be shown to allow for a determination of the resolution.

For example, consider that A is channel response and f is frequency. It may be that an acquired sparse equation indicates that ΔA/Δf is a function, F, of parameters such as a user's position, a signal strength, a delay and an angle, θ. It follows that, upon obtaining measurements for the user's position, the signal strength and the delay, a value for the dynamic, ΔA/Δf, of the channel response, A, with respect to the frequency, f, may be estimated. The value for the dynamic, ΔA/Δf, may be shown to indicate a degree to which the channel response, A, is selective over a range of frequencies, f.

It may be that, in the case of user-X, the value obtained for the dynamic, ΔA/Δf, is relatively large, indicating that the channel response changes quickly over frequency for this user (highly selective). Responsive to obtaining a relatively large value for the dynamic, ΔA/Δf, a system may use relatively small subcarriers.

It may be that, in the case of user-Y, the value obtained for the dynamic, ΔA/Δf, is relatively small, indicating that the channel response changes slowly over frequency for this user (less selective). Responsive to obtaining a relatively small value for the dynamic, ΔA/Δf, a system may use relatively large subcarriers.

When a system is equipped with an ability to obtain a sparse equation in accordance with aspects of the present application, the system may deduce a manner in which the channel response, A, will change with respect to the frequency, f, on the basis of measurements of the user's position, the signal strength and the delay.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method, comprising:
obtaining a library function based on a measurement vector, wherein the measurement vector represents a plurality of measurements of a wireless communication environment and the measurement vector;
obtaining a trained sparse coefficient matrix by optimizing a training target by:
obtaining, using an input data vector and first phase training of a deep neural network autoencoder, an output data vector;
wherein the first phase training comprises:
learning an encoder gradient for an encoder part of the deep neural network autoencoder; and
learning a decoder gradient for a decoder part of the deep neural network autoencoder, and
wherein, the optimizing the training target comprises minimizing a loss function;
obtaining, via second phase training of the deep neural network autoencoder, a primary predicted derivative of the input data vector, wherein the second phase training uses:
the encoder gradient;
the decoder gradient; and
a derivative of the input data vector;
obtaining, via third phase training of the deep neural network autoencoder, a secondary predicted derivative of the input data vector, wherein the third phase training uses:
the library function;
the sparse coefficient matrix; and
the decoder gradient;
obtaining, based on a combination of the sparse coefficient matrix and the library function, a sparse equation; and
transmitting, to a device in the wireless communication environment, an indication of an adjustment to a parameter in use in the wireless communication environment, the adjustment to the parameter determined using the sparse equation.

2. The method of claim 1, wherein the plurality of measurements comprise at least one of time-dynamic samples, space-dynamic samples or code-dynamic samples.

3. The method of claim 1, wherein the loss function relates to a difference between the input data vector and the output data vector.

4. The method of claim 1, wherein the training target comprises a term related to a difference between the derivative of the input data vector and the primary predicted derivative of the input data vector.

5. The method of claim 1, wherein the training target comprises a term related to a difference between the primary predicted derivative of the input data vector and the secondary predicted derivative of the input data vector.

6. The method of claim 1, wherein an output of the encoder part of the deep neural network autoencoder, responsive to the input data vector, is a latent vector and wherein the training target comprises a term related to a difference between the latent vector and the measurement vector.

7. The method of claim 1, wherein an output of the encoder part of the deep neural network autoencoder, responsive to the derivative of the input data vector, is a latent derivative vector and wherein the training target comprises a term related to a difference between the latent derivative vector and a derivative of the measurement vector.

8. The method of claim 1, wherein the parameter relates to:
a density of demodulation reference signals;
a number of sub-carriers;
a sub-carrier spacing;
scheduling transmission to multiple users;
compressing channel measurements;
a speed at which channels are measured;
allocation, to users, of radio resources.

9. The method of claim 8, wherein the radio resources comprise one or more of a coding rate, a bandwidth or a band.

10. An apparatus comprising:
at least one processor coupled with a non-transitory computer-readable medium storing instructions, where when the instructions executed by the at least one processor, cause the apparatus to:
obtain a library function based on a measurement vector, wherein the measurement vector represents a plurality of measurements of a wireless communication environment and the library function represents a set of candidate non-linear functions of columns of the measurement vector;
obtain a trained sparse coefficient matrix by optimizing a training target by:
obtaining, using an input data vector and first phase training of a deep neural network autoencoder, an output data vector;
wherein the first phase training comprises learning an encoder gradient for an encoder part of the deep neural network autoencoder and learning a decoder gradient for a decoder part of the deep neural network autoencoder, and
wherein, the optimizing the training target comprises minimizing a loss function;
obtain, via second phase training of the deep neural network autoencoder, a primary predicted derivative of the input data vector, wherein the second phase training uses:
the encoder gradient;
the decoder gradient; and
a derivative of the input data vector;
obtain, via third phase training of the deep neural network autoencoder, a secondary predicted derivative of the input data vector, wherein the third phase training uses:
the library function;
the sparse coefficient matrix; and
the decoder gradient;
obtain, based on a combination of the sparse coefficient matrix and the library function, a sparse equation; and
transmit, to a device in the wireless communication environment, an indication of an adjustment to a parameter in use in the wireless communication environment, the adjustment to the parameter determined using the sparse equation.

11. The apparatus of claim 10, wherein the plurality measurements comprise at least one of time-dynamic samples, space-dynamic samples or code-dynamic samples.

12. The apparatus of claim 10, wherein the loss function relates to a difference between the input data vector and the output data vector.

13. The apparatus of claim 10, wherein the training target comprises a term related to a difference between the derivative of the input data vector and the primary predicted derivative of the input data vector.

14. The apparatus of claim 10, wherein the training target comprises a term related to a difference between the primary predicted derivative of the input data vector and the secondary predicted derivative of the input data vector.

15. The apparatus of claim 10, wherein an output of the encoder part of the deep neural network autoencoder, responsive to the input data vector, is a latent vector and wherein the training target comprises a term related to a difference between the latent vector and the measurement vector.

16. The apparatus of claim 10, wherein an output of the encoder part of the deep neural network autoencoder, responsive to the derivative of the input data vector, is a latent derivative vector and wherein the training target comprises a term related to a difference between the latent derivative vector and a derivative of the measurement vector.

17. The apparatus of claim 10, wherein the parameter relates to:
a density of demodulation reference signals;
a number of sub-carriers;
a sub-carrier spacing;
scheduling transmission to multiple users;
compressing channel measurements;
a speed at which channels are measured; or
allocation, to users, of radio resources.

18. The apparatus of claim 17, wherein the radio resources comprise one or more of a coding rate, a bandwidth or a band.

19. A non-transitory computer readable medium storing instructions thereon, where when the instructions are executed by at least one processor, cause the at least one processor to:
obtain a library function based on a measurement vector, wherein the measurement vector represents a plurality of measurements of a wireless communication environment and the measurement vector;
obtain a trained sparse coefficient matrix by optimizing a training target by:
obtaining, using an input data vector and first phase training of a deep neural network autoencoder, an output data vector;
wherein the first phase training comprises learning an encoder gradient for an encoder part of the deep neural network autoencoder and learning a decoder gradient for a decoder part of the deep neural network autoencoder, and
wherein, the optimizing the training target comprises minimizing a loss function;
obtain, via second phase training of the deep neural network autoencoder, a primary predicted derivative of the input data vector, wherein the second phase training uses:
the encoder gradient;
the decoder gradient; and
a derivative of the input data vector;
obtain, via third phase training of the deep neural network autoencoder, a secondary predicted derivative of the input data vector, wherein the third phase training uses:
the library function;
the sparse coefficient matrix; and
the decoder gradient;
obtain, based on a combination of the sparse coefficient matrix and the library function, a sparse equation; and
transmit, to a device in the wireless communication environment, an indication of an adjustment to a parameter in use in the wireless communication environment, the adjustment to the parameter determined using the sparse equation.

20. The non-transitory computer readable medium of claim 19, wherein the plurality measurements comprise at least one of time-dynamic samples, space-dynamic samples or code-dynamic samples.
